(19) United States
(12) Patent Application Publication
(10) Pub. No.: US 2026/0192305 A1
(43) Pub. Date: Jul. 9, 2026

(54) CARRIAGE WITH CLAMP PLATE FOR SECURING SAMPLE-PROCESSING TUBES

(71) Applicant: OMNI INTERNATIONAL, INC., Kennesaw, GA (US)

(72) Inventors: Miles PRESTWOOD, Kennesaw, GA (US); William Z. TODD, Kennesaw, GA (US)

(21) Appl. No.: 19/442,298

(22) Filed: Jan. 7, 2026

Related U.S. Application Data
(60) Provisional application No. 63/742,966, filed on Jan. 8, 2025.

(51) Int. Cl. B01L 9/06

(52) U.S. Cl. CPC B01L 9/06; B01L 2200/025; B01L 2200/18; B01L 2300/042

(57) ABSTRACT

A carriage holds a tube holder holding tubes containing samples and mounts to a processing device. The carriage includes a housing that contains the tube holder and tubes, a clamp plate that moves between clamping and clearance positions, and a controller operable to move the clamp plate between the clearance and clamping positions. In some embodiments, the carriage includes a bottom lip that retains the tube holder and tubes within the carriage in a seated position. In some embodiments, the controller includes an elongated rotary control member and a collar, with the collar fixedly attached to the clamp plate and having screw threads, and with the control member rotationally mounted to the housing and having screw threads that mate with the collar threads so that rotating the control member drives the clamp plate between the clamping and clearance positions, without the control member moving up or down.

### CROSS-REFERENCE TO RELATED APPLICATION

This application claims the priority benefit of U.S. Provisional Patent Application Serial Number 63/742,966, filed January 8, 2025, which is hereby incorporated herein by reference.

### TECHNICAL FIELD

The present disclosure relates generally to laboratory devices and methods for processing sample materials, and particularly to mechanisms for securing sample tubes during use with homogenizing and other processing devices and methods.

### BACKGROUND

Homogenization involves disaggregating, mixing, resuspension, or emulsifying the components of a sample using a high-shear process with significant micron-level particle-size reduction of the sample components. Homogenization is commonly used for a number of laboratory applications such as creating emulsions, reducing agglomerate particles to increase reaction area, cell destruction for capture of DNA material (proteins, nucleic acids, and related small molecules), DNA and RNA amplification, and similar activities in which the sample is bodily (animal or plant) tissue and/or fluid, other organic material, or another substance.

Conventional high-powered mechanical-shear homogenization devices for such applications are commercially available in various designs to generate vigorous linear, circular, or “swashing” (modified sinusoidal) oscillating (e.g., reciprocating) motions and resulting forces. The samples are held in sample tubes, with a plurality of the sample-holding tubes mounted to a tube holder that is mounted to the homogenization device such that the vigorous oscillating forces are transmitted through the tube holders and the tubes to the contained samples.

In some conventional homogenization devices, the tube holders are integrated into the homogenization devices so that the tubes are individually loaded onto

the homogenization devices. In other conventional homogenization devices, the tube holders are mountable to the homogenization devices by clamps or other securing mechanisms, with a plurality of the tubes preloaded into the tube holder and the loaded tube holder then mounted to the homogenization device for use. Such clamp mechanisms are generally beneficial in some regards, but in use they have their disadvantages. For example, they tend to be prone to damage and/or failure during use resulting from the extremely high energy of the devices and/or from user error (these mechanisms are not the easiest to use).

As such, current mechanisms for mounting tube holders to homogenizing devices tend to be difficult to use, in need of frequent replacement, or both.

### SUMMARY

Generally described, the present disclosure relates to a carriage for holding one or more tube holders comprising one or more tubes containing samples and for mounting to a processing device. In example embodiments, the carriage includes a housing that contains the tube holder and tubes, a clamp plate that moves between clamping and clearance positions, and a controller operable to move the clamp plate between the clearance and clamping positions. The housing including an interior space and a side opening in communication with the interior space, with the interior space configured to contain the tube holder with tubes, with the side opening configured to receive the tube holder with tubes into the interior space. The housing also includes at least one mount configured to attach to the processing device. The clamp plate is positioned within the housing interior space and moves between a clamping position and a clearance position. In the clearance position, the clamp plate provides clearance enabling the tube holder with tubes to be inserted into and removed from the interior space. And in the clamping position, with the tube holder with tubes within the interior space, the clamp plate contacts the tube holder and/or the tubes to retain the tube holder with tubes between the clamp plate and the housing in a fixed position during use of the processing device to process the samples. The controller includes a control member and a driven member engaged and driven by the control member, with the control member and the driven member adapted to selectively move the clamp plate between the clearance and clamping positions.

is adapted to selectively move the clamp plate between the clearance and clamping positions.

In typical embodiments, the housing includes a bottom, a top, and four sides extending between the top and the bottom, with the side opening formed in a front one of the housing sides. The clamp plate clearance position is raised within the housing interior space relative to the clamp plate clamping position, and the clamp plate in the clamping position applies a compressive force between the clamp plate and the housing bottom.

In some embodiments, the housing includes a bottom lip that retains the tube holder with tubes within the carriage when the tube holder with tubes is in a seated position within the housing interior space. For example, the bottom lip can be positioned below the side opening, have a top edge that defines a bottom of the side opening, and have an inner surface that defines a portion of the housing interior space. The tube holder with tubes inserts laterally through the side opening, over the top edge of the bottom lip, and into the interior space, and then drops downward within the interior space into the seated position. When the tube holder with tubes is in the seated position, the inner surface of the bottom lip retains the tube holder with tubes from moving laterally back out through the side opening.

Typically, all of the tubes in the tube holder have the same relatively taller or shorter height, and the controller is configured to move the clamp plate between a range of the clearance and clamping positions. As such, the clearance and clamping positions are not discrete positions but instead are determined by the height of the tubes being clamped. Thus, for the relatively taller tubes the clamp plate is lowered less to the clamping position than for the relatively shorter tubes. Also, the clamp plate in the clamping position typically contacts a portion of the tubes extending above the tube holder.

In some embodiments, the control member is an elongated rotary control member and the driven member is a collar, with the control member rotationally mounted to the housing so that the control member rotates, but does not move up or down, relative

to the housing. The collar is fixedly attached to the clamp plate and engaged by the control member so that rotation of the control member moves the clamp plate between the clamping and clearance positions. For example, the clamp plate can include a vertically extending opening, with the elongated rotary control member extending through the clamp plate opening, and with the collar aligned with the clamp plate opening and receiving the control member through it. The elongated rotary control member can be a control rod having screw threads, with the collar having screw threads that mate with the control member threads so that rotation of the control member drives the clamp plate between the clamping and clearance positions.

In such embodiments, the housing and the clamp plate include abutting contact surfaces that abut each other to restrain the clamp plate from rotating with the control member to thereby cause the clamp plate to move between the clamping and clearance positions. For example, the housing and the clamp plate can include mating guide tabs and slots that define the mating contact surfaces, with the guide tabs and slots adapted to guide the clamp plate between the clamping and clearance positions.

In typical embodiments, the elongated rotary control member extends all the way through the housing, between the top and bottom of the housing, and is rotationally mounted to the housing top and bottom. In such embodiments, the control member can include an input end extending above the housing, and the controller can also include a control interface attached to the control member input end and adapted to rotate the control member, so that the control interface rotates, but does not move up or down, relative to the housing.

In some embodiments, the controller also includes a lock mechanism for the clamp plate. The controller includes a catch member coupled to the elongated rotary control member and an engagement member selectively movable between locked and released positions. In the released position, the engagement element is free of engagement with the catch member so that the control member is free to rotate in a first angular direction to move the clamp plate to the clamping position and in an opposite second angular direction to move the clamp plate to the clearance position. In the locked position, the engagement element engages the catch member so that the control member is restrained from rotating in the second angular direction to retract the clamp plate toward the clearance position so that the clamp plate secures the tube holder with tubes in place.

In such embodiments, the catch member can be a ratchet and the engagement member can be a pawl. In the locked position, the control member is free to rotate in the first angular direction to advance the clamp plate to the clamping position.

Another embodiment includes the processing device and the carriage in combination. In some such embodiments, the processing device is a homogenizer and the carriage is attached to the homogenizer.

In further example embodiments, the carriage includes a housing that contains the tube holder and tubes, a clamp plate that moves between clamping and clearance positions, and a controller operable to move the clamp plate between the clearance and clamping positions. The housing includes an interior space, a side opening in communication with the interior space, and a bottom lip. The interior space is configured to contain the tube holder with tubes, and the side opening is configured to receive the tube holder with tubes into the interior space. The bottom lip is configured to retain the tube holder with tubes within the carriage when the tube holder with tubes is in a seated positioned within the housing interior space. The clamp plate is positioned within the housing interior space, includes a vertically extending opening, and is movable between a clamping position and a clearance position. In the clearance position, the clamp plate provides clearance enabling the tube holder with tubes to be inserted into and removed from the interior space. In the clamping position, with the tube holder with tubes within the interior space, the clamp plate contacts the tube holder and/or the tubes to retain the tube holder with tubes between the clamp plate and the housing in a fixed position during use of the processing device to process the samples. The controller is adapted to selectively move the clamp plate between the clearance and clamping positions. The controller can include an elongated rotary control member and a collar. The control member can include screw threads, extend through the clamp plate opening, and be rotationally mounted to the housing so that the control member rotates, but does not move up or down, relative to the housing. The collar can be fixedly attached to the clamp plate, be aligned with the clamp plate opening, receive the control member through it, and have screw threads that mate with the control member threads so that rotation of the control member drives the clamp plate between the clamping and clearance positions. Also, the housing and the clamp plate can include abutting contact surfaces that restrain the clamp plate from rotating with the elongated rotary control member to thereby cause the clamp plate to move between the clamping and clearance positions.

In typical embodiments, the controller also includes a lock mechanism for the clamp plate. The controller includes a catch member coupled to the elongated rotary control member and an engagement member selectively movable between locked and released positions. In the released position, the engagement element is free of engagement with the catch member so that the control member is free to rotate in a first angular direction to move the clamp plate to the clamping position and in an opposite second angular direction to move the clamp plate to the clearance position. In the locked position, the engagement element engages the catch member so that the control member is restrained from rotating in the second angular direction to retract the clamp plate toward the clearance position, so that in the locked position the clamp plate secures the tube holder with tubes in place.

In some embodiments, the housing interior space is configured to contain two of the tube holders each holding an array of the sample tubes.

Another embodiment includes the processing device and the carriage in combination. In some such embodiments, the processing device is a homogenizer and the carriage is attached to the homogenizer.

The specific techniques and structures employed to improve over the drawbacks of the prior devices and accomplish the advantages described herein will become apparent from the following detailed description of example embodiments and the appended drawings and claims.

### BRIEF DESCRIPTION OF THE DRAWINGS

FIG. 1 is a perspective view of a portion of a processing device including a tube carriage according to a first example embodiment, with a housing of the processing device removed to reveal the internal components shown, with the carriage holding a tube

holder carrying tubes, and with the carriage shown schematically to be representative of multiple embodiments.

FIG. 2 is a perspective view of the carriage, tube holder, and tubes of FIG. 1, with the tube holder and tubes partially inserted into the carriage.

FIG. 3 is a front view of the carriage, tube holder, and tubes of FIG. 2, with the tube holder and tubes fully inserted into the carriage.

FIG. 4 is a perspective view of the carriage, tube holder, and tubes of FIG. 3, with the tube holder and tubes lowered into a seated position within the carriage.

FIG. 5 is a side view of the carriage, tube holder, and tubes, in partial cross section taken at line 5-5 of FIG. 4, with the clamp plate lowered into a clamping position.

FIG. 6 is a perspective view of the carriage, tube holder, and tubes of FIG. 5, showing the controller operated to lower and raise the clamp plate between clamping and clearance positions.

FIG. 7 is a front schematic view of the carriage, tube holder, and tubes of FIG. 6.

FIG. 8 is a perspective view of a portion of the carriage of FIG. 6, showing the controller, the clamp plate, and the top of the carriage.

FIG. 9 is a perspective view of the controller of FIG. 8, shown in an exploded/disassembled arrangement.

FIG. 10 is a perspective view of the clamp plate and a portion of the controller of FIG. 8, shown in an exploded/disassembled arrangement.

FIG. 11 is a top view of the carriage, in cross section taken at line 11-11 of FIG. 3, showing the clamp plate engaged by the carriage to constrain the clamp plate from rotation and guide the clamp plate through its vertical movement.

FIG. 12 is a side cross-sectional view of the carriage of FIG. 5, showing the clamp plate in the raised clearance position of FIGS. 2-4.

FIG. 13 shows the carriage of FIG. 12 with the clamp plate lowered to the clamping position of FIGS. 5-6 and 14-15.

FIG. 14 is a front view of the carriage, tube holder, and tubes of FIG. 6, showing the clamp plate in the lowered clamping position securing the tube holder and tubes within the carriage and ready for processing use.

FIG. 15 shows the carriage of FIG. 14 and an alternative tube holder and tubes.

FIG. 16 is a top view of the controller of FIG. 9, with the control interface knob removed to show a lock mechanism in a locked position preventing the clamp plate from being retracted.

FIG. 17 shows the controller of FIG. 16 with the lock mechanism in a release position enabling the clamp plate to being retracted.

FIG. 18 is a top view of a tube carriage according to a second example embodiment, with the carriage holding a tube holder carrying tubes.

FIG. 19 is a top view of the controller of the carriage of FIG. 18, with the control interface knob removed to show a lock mechanism in a locked position preventing the clamp plate from being retracted.

FIG. 20 shows the controller of FIG. 19 with the lock mechanism in a release position enabling the clamp plate to being retracted.

### DETAILED DESCRIPTION OF EXAMPLE EMBODIMENTS

Generally described, the present disclosure relates to carriages for mounting tube holders to homogenization (or other processing) devices and securing them in place during homogenizing (or other processing). The tube holders each hold a plurality of tubes, which each hold a sample to be homogenized or otherwise processed by the oscillating motions (e.g., cyclically circular, linearly reciprocating, or swashing) and resulting forces on the tubes and thus on the samples contained in the tubes. The carriages provide for simple and easy mounting of the tube-laden tube holders to the processing devices and a longer life withstanding the extremely high energy and forces of processing use.

It should be noted that the carriages can be used with different types of processing devices, tube holders, tubes, and sample materials, and as such these terms as used herein are intended to be broadly construed. A few preliminary definitions are as follows. These definitions are all in the context of laboratory processing equipment and methods, with the term “laboratory” intended to be broadly construed to mean any type of controlled sterile environment used for processing samples, including clinical diagnostic and pathology laboratories, academic and industry research laboratories, and teaching laboratories.

“Processing” as used herein is intended to be broadly construed to mean high-shear disaggregating, with significant micron-level particle-size reduction (and optionally mixing and/or resuspending) of the components of a sample, by using a processing device to generate an oscillating motion of a tube containing the sample. Example types of processing include homogenizing, emulsifying, lysing, grinding, and pulverizing, blending, mixing, resuspending, and other uses/applications of laboratory processing devices (e.g., dissociating, separating, rupturing, combining, cutting, crushing, and breaking apart).

“Processing device” as used herein is intended to be broadly construed to mean a laboratory device that is operable to drive tubes holding samples through an oscillatory motion to process the samples. A common but non-exclusive example processing device is a bead mill homogenizer, for example BEADRUPTER bead mill homogenizers (Omni International, Inc., Kennesaw, GA), that operates to homogenize the samples.

“Sample” as used herein is intended to be broadly construed to include any type of material that can be processed and for which processing could be useful, such as but not limited to human and/or non-human animal bodily fluid and/or tissue (e.g., blood, bone-marrow cells, a coronary artery segment, a piece of an organ, or whole or parts of insects or other animals), other organic matter (e.g., plants or food), and/or other chemicals, substances (e.g., soil), or biological materials.

“Tube” is intended to be broadly construed to include any closable/sealable vessel or container that can hold a sample (sometimes also holding a grinding media such as beads) during processing and is not limited to conventional cylindrical hard-plastic vials with screw-on caps and thus also includes wells (e.g., of well plates), conical, polygonal, or other-shaped vials, and other types of elongated, spherical, or other-shaped vessels and containers.

“Tube holder” is intended to be broadly construed to include any retaining structure that can hold a plurality of sample tubes during processing and that can be operably driven by a shaking mechanism, and is not limited to conventional racks (e.g., SBS racks), plates (e.g., of well plates), trays, cassettes, clamps, or other types of tube-holding structures, with typical tube holders having a rectangular footprint and holding an array (e.g., 3 x 6) of tubes. As used herein, tube holders expressly include well plates, which are effectively integrated tube holders (the plates) and tubes (the wells).

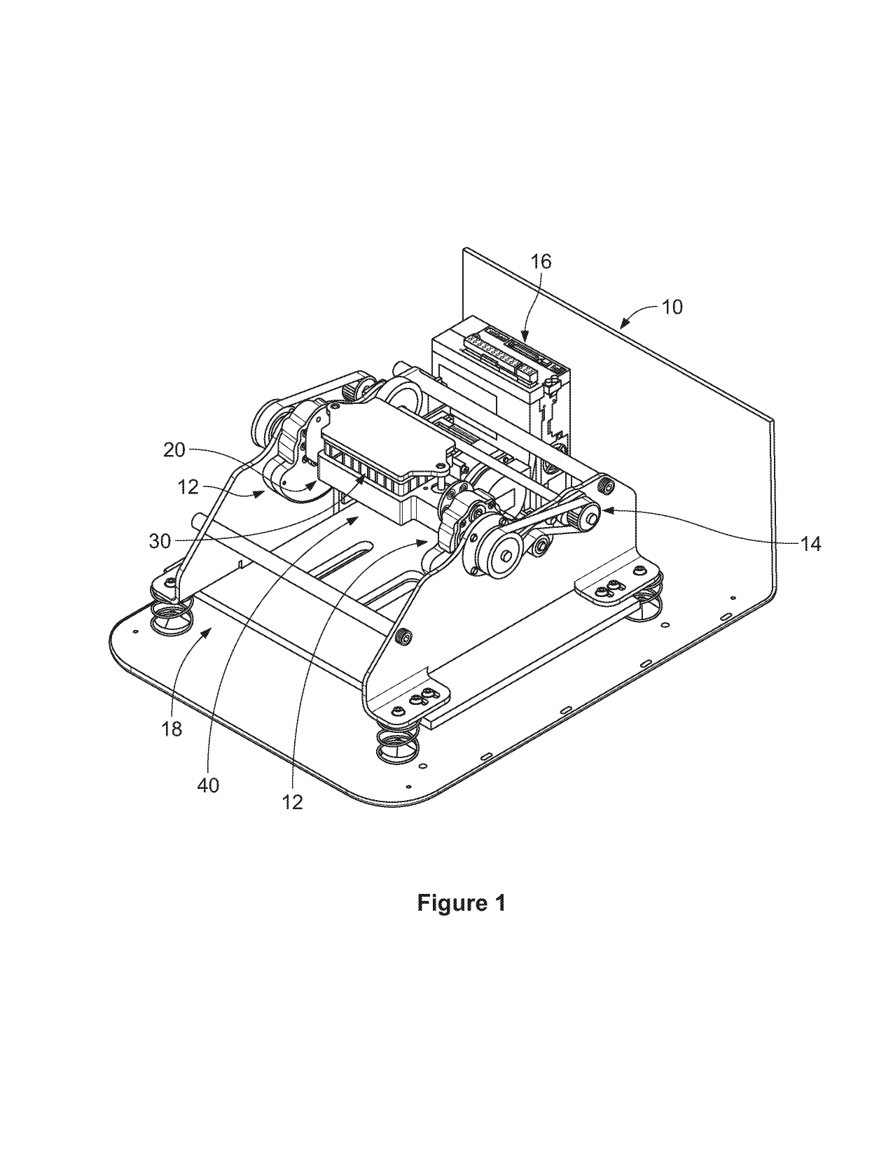

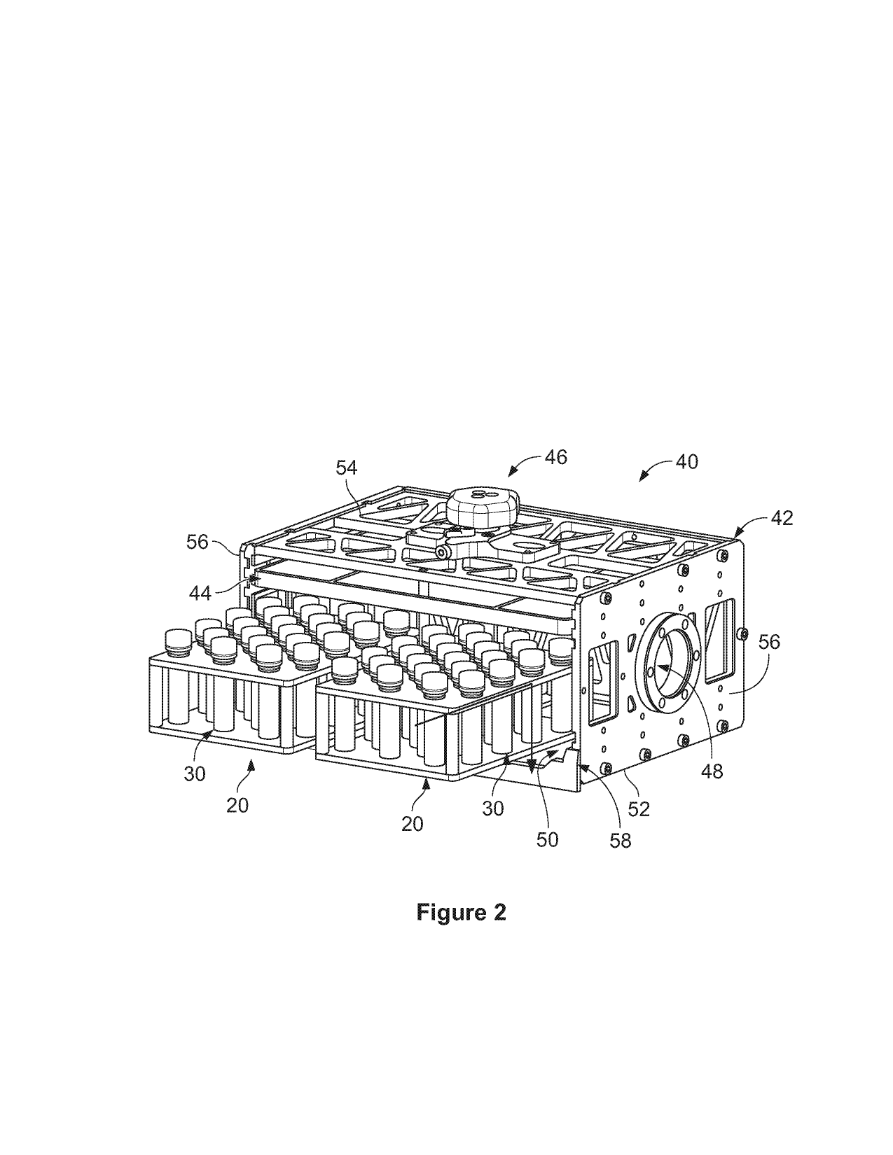

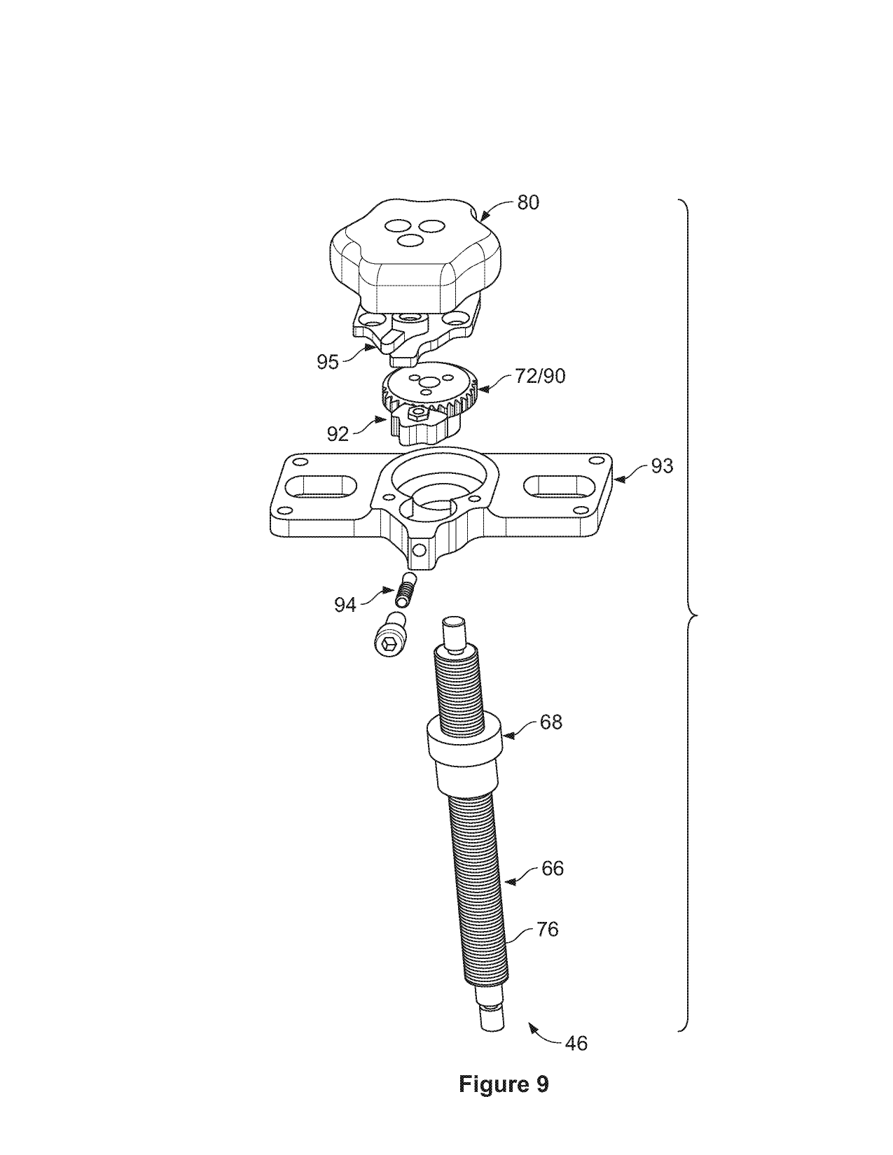

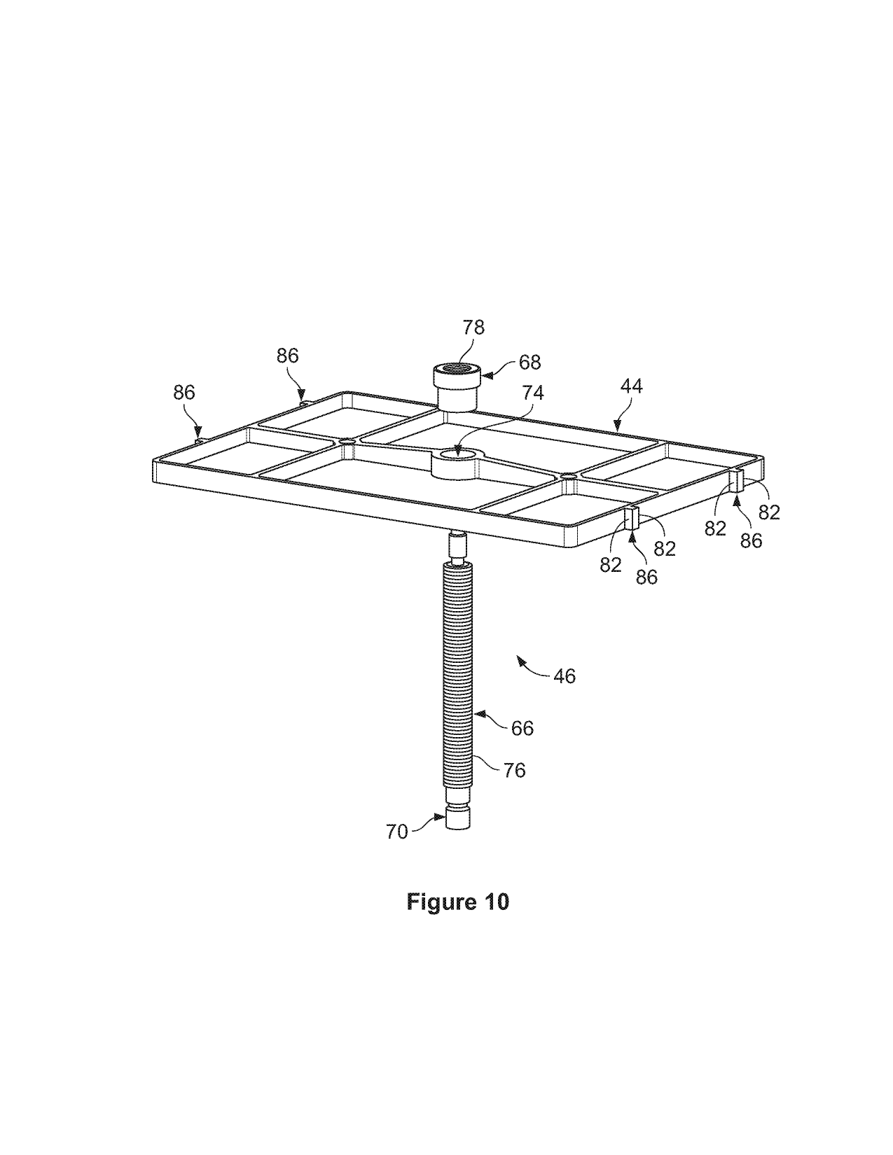

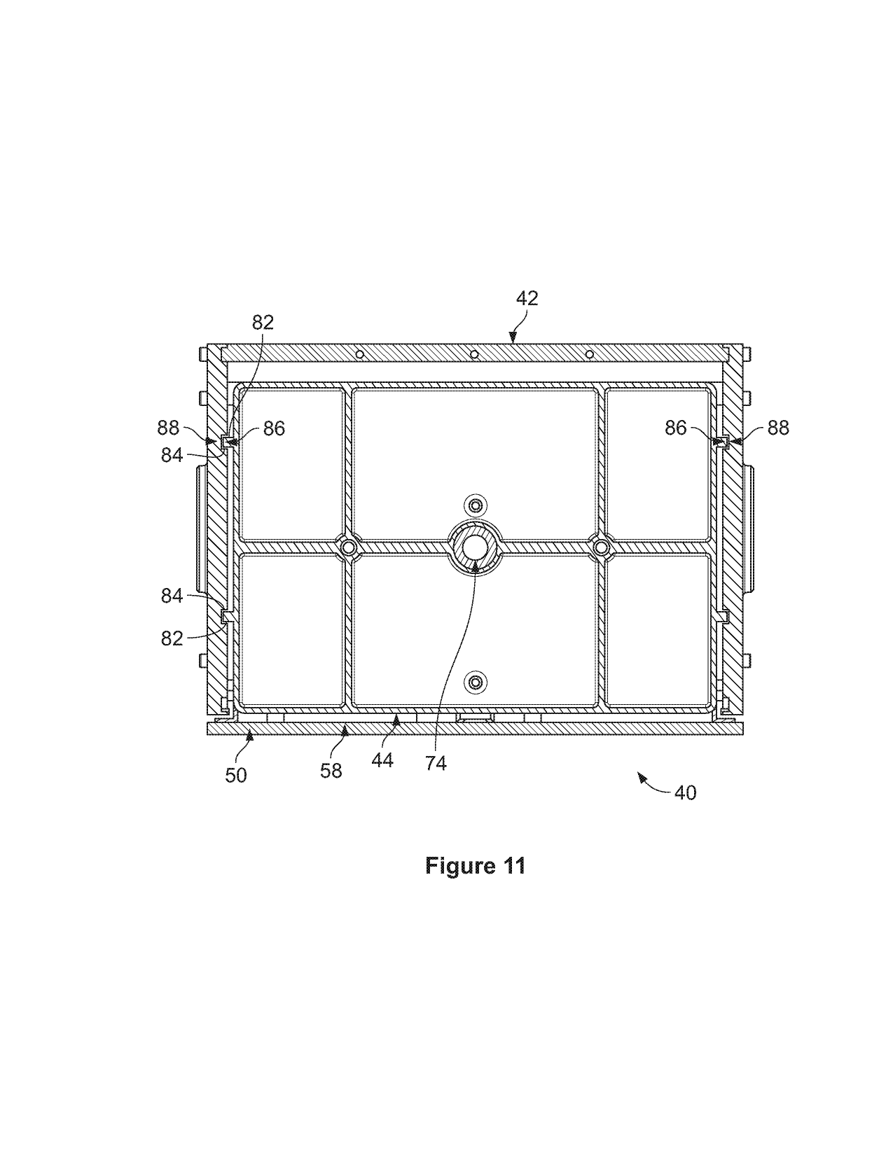

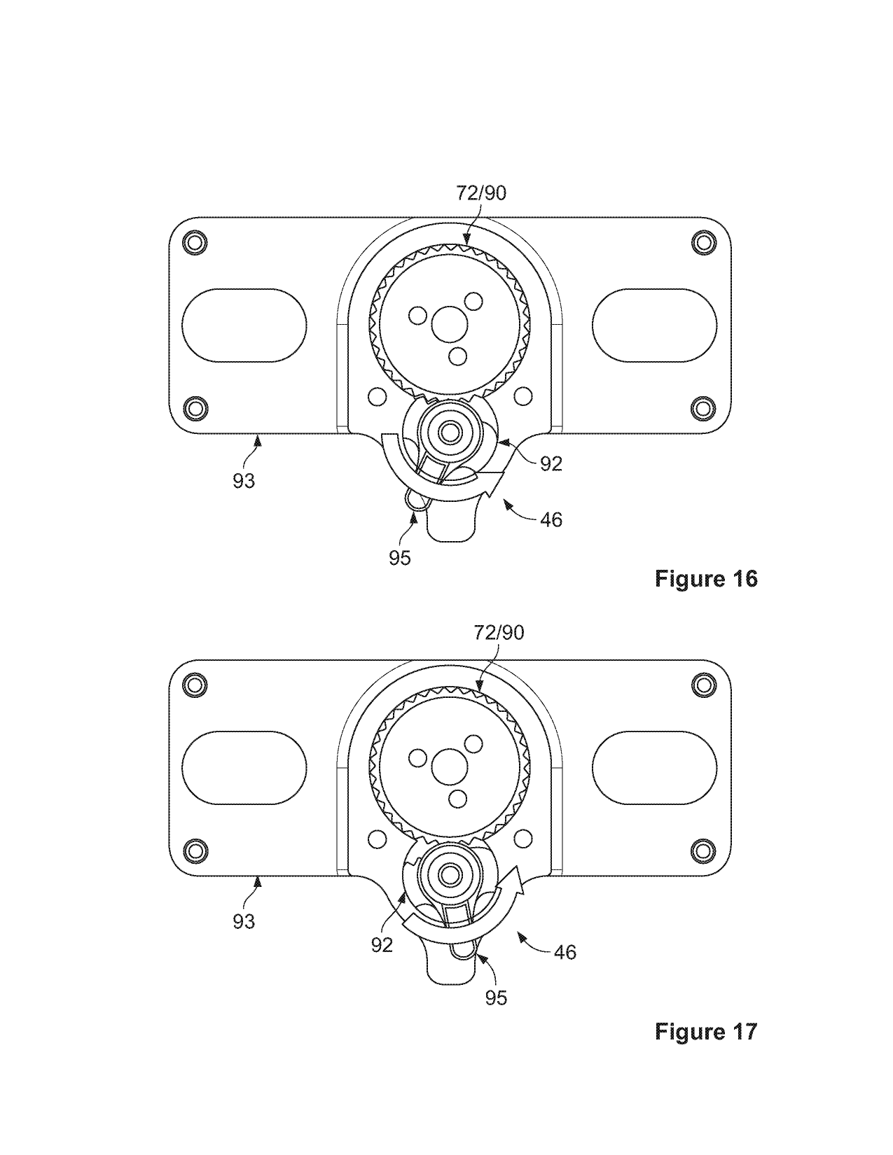

Turning now to the drawings, FIGS. 1-17 show a portion of a processing device 10 including a carriage 40 according to an example embodiment. Referring particularly to FIGS. 1-2, the processing device 10 that the carriage 40 is incorporated into can be a laboratory homogenizer (e.g., as depicted), or another conventional or future-designed processing device. For example, the processing device 10 can be a modified bead mill homogenizer, such as a BEADRUPTER bead mill homogenizer (Omni International, Inc., Kennesaw, GA). In other embodiments, the carriage is removably mounted to the processing device so that it can be changed in and out as desired based on the processing workflow.

The processing device 10 typically includes a shaking mechanism 12, a drive system 14 for driving the shaking mechanism 12, a control system 16 for operating the drive system 14, a frame 18 that supports the shaking mechanism 12, the drive system 14, and the control system 16, and a housing (not depicted) for at least partially enclosing these components. The drive system 14 typically includes an electric rotary motor operably linked to and driving the shaking mechanism 12, for example by a roller- and-belt linkage (such as a first roller driven by the motor, a second roller driving the shaking mechanism 40, and a belt routed around the rollers to transfer rotational motion from the motor to the shaking mechanism 40, as depicted). The control system 16 typically includes a programmed controller, input devices (e.g., buttons and a keypad), and output devices (e.g., a display screen), for providing functions such as on/off, start/stop, speed, and time. An electric power connection (e.g., a power cord) or source (e.g., battery) is typically included for powering the drive system 14 and the control system 16. The frame 18 typically includes two opposing side frame members with the shaking mechanism 12 extending and mounted between them. These major components of the processing device 10 can be of a conventional type well known in the art, so exacting details are not included herein.

The shaking mechanism 12 operates to generate and transmit oscillating motions and resulting forces through a tube holder 20 holding a plurality of tubes 30 each containing a sample material to process the samples. Thus, the oscillating forces are transferred to and through the carriage 40, then to and through the tube holder 20, then to and through the tubes 30, and then to the samples to process them. The tube holder 20 can be a rack (e.g., as depicted) and the tubes 30 can be elongated screw-cap vials (e.g., as depicted), or these components can be provided by well plates. These tube holder 20 and tube 30 components used with the processing device 10 can be of a conventional type well known in the art, so exacting details are not included herein.

In the depicted embodiments, the shaking mechanism 12 operates to generate and transmit circular oscillating motions and resulting forces. That is, the shaking mechanism 12 drives the carriage 40 through a circular oscillating motion (rotating about an axis that is transverse to the longitudinal axes of the tubes, not an axis that is parallel with the longitudinal axes of the tubes as in conventional centrifuges), with all of the tubes 30 in the tube holder 20 moved through the same circular motion profile while being maintained in the same orientation (e.g., generally vertically upright) throughout the entire circular motion profile. In this way, the tubes 30 (and samples in them) all experience the same oscillatory forces to provide uniform and consistent processing results. The oscillatory forces on the tubes are thus (primarily/exclusively) in a plane perpendicular to the transverse rotational axis, that is, vertically (up and down) and horizontally deep (sideways front and back), but not horizontally wide (sideways left and right). The carriage 40 is well-suited for use with shaking mechanisms producing this type of circular motion profile with uniform tube orientation. In addition, the carriage 40 can be used with processing devices having other types of shaking mechanisms producing other motion profiles, for example, cyclically circular about an axis that is transverse to the longitudinal axes of the tubes (but with the tube orientation changing throughout the circular motion profile), cyclically circular about an axis that is parallel with the longitudinal axes of the tubes (as in conventional centrifuges), linearly reciprocating, swashing, or any other motion profile.

Referring particularly to FIGS. 2-5, the carriage 40 includes a housing 42, a clamp plate 44, and a controller 46. The housing 42 receives and contains the tube holder 20 and tubes 30. The clamp plate 44 moves between a clamping position securing the tube holder 20 and tubes 30 within the housing 42 and a clearance positioned for inserting and removing the tube holder 20 and tubes 30 into and out of the housing 42. And the controller 46 is operable to move the clamp plate 44 between the clamping and clearance positions. These components can be made of conventional materials (e.g., hard plastic or metal) using conventional fabrication techniques and equipment.

The housing 42 defines an interior space 48 and a side opening 50 in communication with the interior space 48. The interior space 48 is configured to contain the tube holder 20 and tubes 30 during processing use. And the side opening 50 is configured to receive the tube holder 20 and tubes 30 to install and remove the tube holder 20 and tubes 30 into and out of the interior space 48.

The housing 42 includes a bottom 52, a top 54, and sides 56 extending between the top and the bottom, with the interior space 48 formed by the bottom 52, top 54, and sides 56, and with the side opening 50 formed in/by one of the sides. The housing bottom 52, top 54, and sides 56 can be solid panels, apertured panels, frameworks, or other structures that provide the functionality of containing the tube holder 20 and tubes 30 during processing use. In the depicted embodiment, the housing 42 is generally rectangular with four sides 56, the side opening 50 is in a front one of the four sides 56, and in the clamping position the clamp plate 44 clamps/compresses the tube holder 20 and tubes 30 against the housing bottom 52. In other embodiments, the housing has a circular, polygonal, or other regular or irregular shape, the side opening is in another part of the housing, and/or the clamp plate clamps/compresses the tube holder and tubes against another part of the housing. Also, it will be understood that the carriage 40 can be readily adapted for mounting to processing devices for processing use in different orientations, for example with the tubes 30 being horizontal and/or with the housing bottom 52 and top 54 being vertical. Further, the housing 42 includes at least one mount where it attaches to the processing device 10, for example two conventional mounts (e.g., brackets, flanges, etc.) with one each at the left and right sides 56 (e.g., with the side opening 50 at the front side between the left and right sides), with the mounts for fixedly or removably attaching the carriage 40 to the processing device 10.

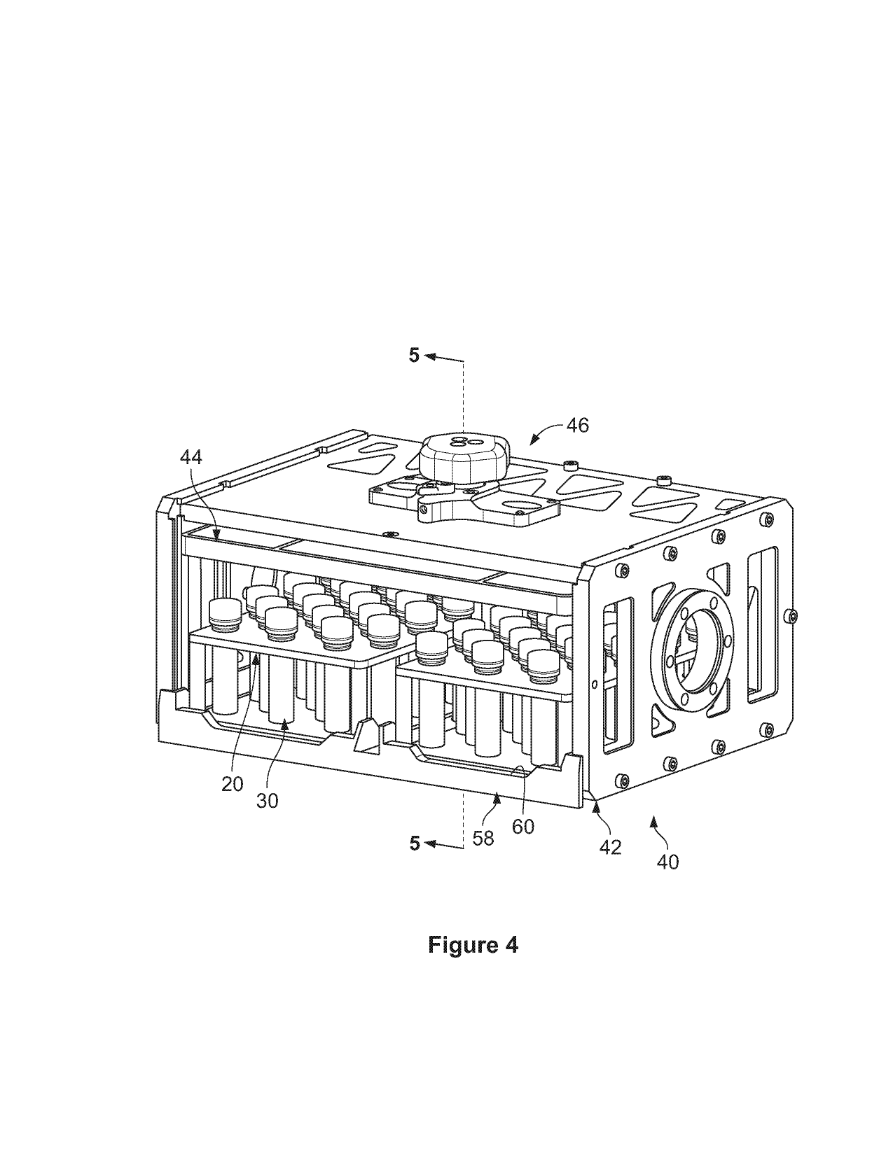

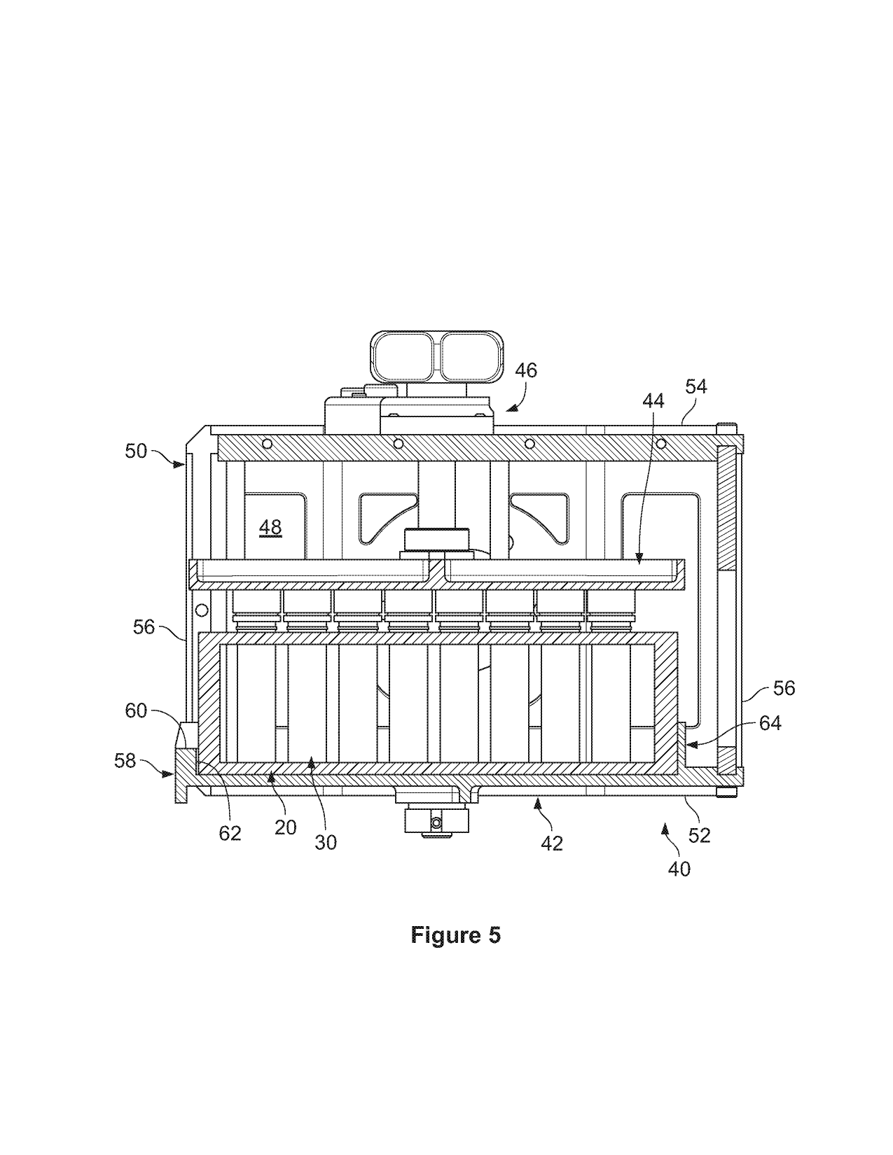

In addition, the housing 42 typically includes a bottom lip 58 that retains the tube holder 20 with tubes 30 within the carriage interior space 48 when the tube holder 20 and tubes 30 are in a seated positioned within the housing interior space 48 (FIGS. 4-5). The bottom lip 58 can be in the form of a continuous panel (as depicted) or another structure (e.g., a horizontal bar or rod, a series of upright posts, etc.) that provides the retaining functionality described herein. The bottom lip 58 typically extends all the way across the side opening 50 between the housing left and right sides 56, though it need not.

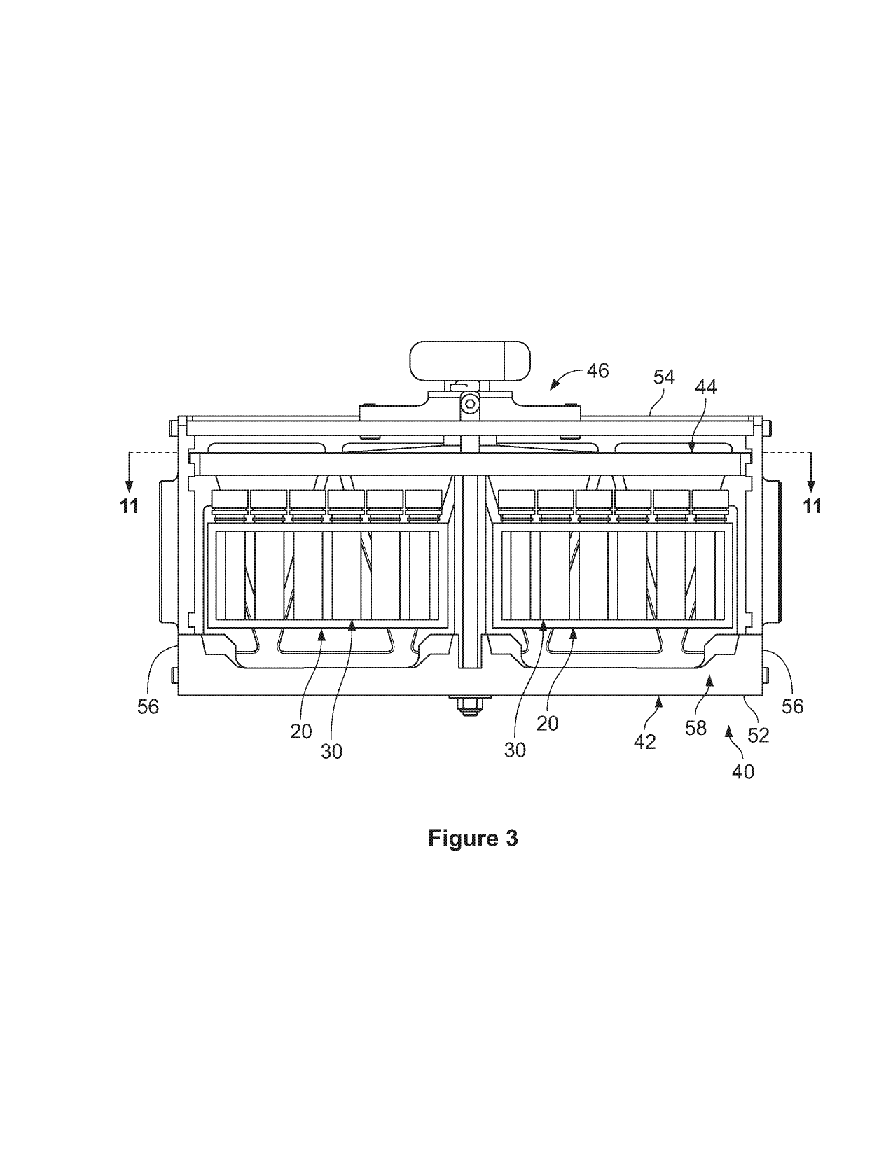

The bottom lip 58 extends above the housing bottom 52 and is positioned below the side opening 50. In particular, the bottom lip 58 has a top edge 60 above the housing bottom 52 that defines a bottom of the side opening 50, and has an inner surface 62 that defines a portion of the housing interior space 48. The tube holder 20 with tubes 30 inserts laterally (e.g., front-to-back) through the side opening 50, over the top edge 60 of the bottom lip 58, and into the interior space 48 (FIGS. 2-3), and then drops downward within the interior space 48 into the seated position (FIGS. 4-5). With the tube holder 20 with tubes 30 in the seated position resting and nested snugly in the housing interior space 48, the inner surface 62 of the bottom lip 58 extends above the bottom of the tube holder 20 with tubes 30. This mechanical interference thereby retains the tube holder 20 with tubes 30 from moving laterally back out of the interior space 48 through the side opening 50.

Further, the bottom lip 58 (at the side opening 50) cooperates with a retaining surface at the opposite (e.g., rear) side of the housing 42 to prevent lateral movement (along that axis, e.g., horizontally/sideways front and back) of the tube holder 20 with tubes 30 during processing use. The cooperating retaining surface can be formed by a cooperating retaining lip 64 (e.g., as depicted in FIG. 5), by the opposite (e.g., rear) side 56 of the housing 42, or by another retaining element.

In this way, the carriage 40 is particularly well suited for use with processing devices 10 having shaking mechanisms 12 generating an oscillating motion producing resulting forces in the plane perpendicular to the rotational axis, specifically along a front/rear side horizontal axis. For example, the carriage 40 is thus well suited for use with processing devices 10 having shaking mechanisms 12 generating a circular oscillating motion with uniform tube orientation (i.e., rotating about an axis transverse to the tube longitudinal axes, with all of the tubes 30 in the tube holder 20 moved through the same circular motion profile while being maintained in the same orientation). It will be understood, however, that the carriage 40 can alternatively be used with processing devices having shaking mechanisms generating other oscillating motions such as those described herein.

The housing 42 can also include cooperating retaining surfaces that prevent lateral movement (horizontally/sideways left and right) of the tube holder 20 with tubes 30 along an axis parallel to the rotational axis. These additional cooperating retaining surfaces can be formed by opposing sides 56 of the housing 42 (with the side opening 50 between them), or by other retaining structures. In some embodiments, however, the clamping/compressing forces of the clamp plate 44 are sufficient to retain the tube holder 20 with tubes 30 from such movement during processing use (for example for use with the depicted shaking mechanism 12). In all embodiments, the housing 42 restrains the tube holder 20 from movement (relative to the housing 42) while the housing 42 moves, regardless of the oscillatory motion (linear, semi-linear, circular, etc.); at no point in any motion is the tube holder 20 allowed to escape the housing 42.

In the depicted embodiment, the housing 42 is configured (e.g., sized and shaped) with the interior space 48 able to contain two of the tube holders 20 each holding an array of the sample tubes 30. The housing can include a center support post (as shown) to assist in withstanding the high forces during processing use, with the support post between the two tube holders 20. In other embodiments, the housing is configured with the interior space able to contain only one tube holder holding an array of the sample tubes. In yet other embodiments, the housing is configured with the interior space able to contain three, four, or more tube holders each holding an array of the sample tubes, for example with at least two of those tube holders in a stacked arrangement.

The clamp plate 44 moves between a clamping position securing the tube holder 20 and tubes 30 within the housing 42 and a clearance positioned for inserting and removing the tube holder 20 and tubes 30 into and out of the housing 42, as noted above. More particularly, the clamp plate 44 is positioned within the housing interior space 48 and moves between the clearance and clamping positions within the interior space 48. In the depicted embodiment, the clamp plate 44 is a solid panel, is rectangular in shape (footprint/plan view, for use within a rectangular housing 42), and has a clearance position that’s vertically raised while its clamping position is vertically lowered. In other embodiments, the clamp plate is formed by an apertured panel, framework, or other structure that provides the clamping functionality, has a circular, polygonal, or other regular or irregular shape (e.g., conforming to the shape of the interior space), and/or moves laterally or through another motion.

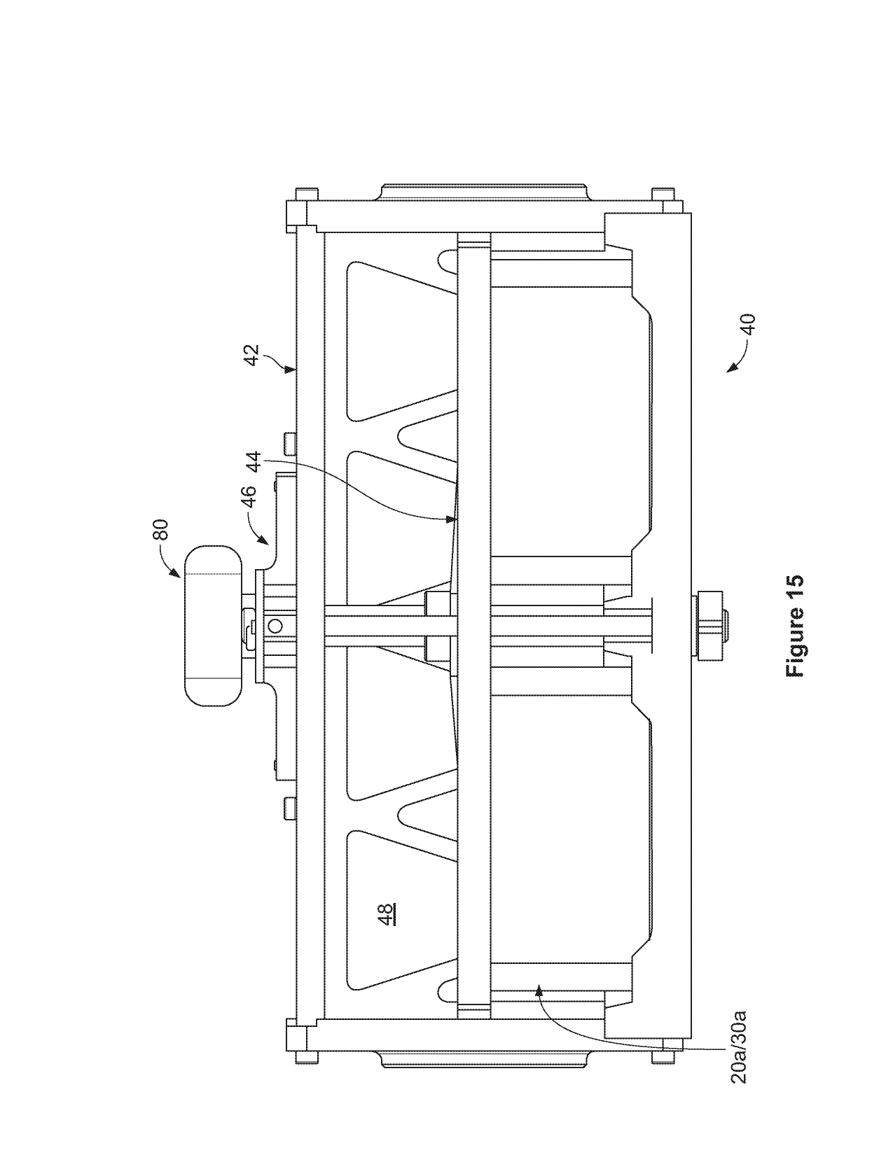

In the clearance position, the clamp plate 44 is positioned to provide clearance for the tube holder 20 with tubes 30 to be inserted laterally through the side opening 52, over the top edge 60 of the bottom lip 58, and into the interior space 48, as noted. So, in the clearance position the clamp plate 44 needs to be farther away from the bottom lip 58 that the height of the tube holder 20 with tubes 30. And in the clamping position, the clamp plate 44 contacts the tube holder 20 and/or the tubes 30 to apply a clamping/compressive force between the clamp plate 44 and the housing 42 to retain the tube holder 20 with tubes 30 in a fixed position during processing use. In the depicted embodiment, the clamp plate 44 contacts a portion of the tubes 30 (the top, which in this case is a screwcap) extending above the tube holder 20 to apply the clamping force (FIG. 5). In other embodiments, the clamp plate contacts a portion of the tube holder or another portion of the tubes (see, e.g., the well plate tube holder of FIG. 15). Also in the depicted embodiment, the clamp plate 44 clamps a bottom surface of the tube holder 20 against the housing bottom 52 (FIG. 5). In other embodiments, the clamp plate clamps another part of the tube holder and/or the tubes against the same or another bearing surface of the housing.

In this way, the carriage 40 with the clamp plate 44 is particularly well suited for use with processing devices 10 having shaking mechanisms 12 generating an oscillating motion producing resulting forces in the plane perpendicular to the rotational axis, specifically along an up/down (vertical) axis. For example, the carriage 40 with the clamp plate 44 is thus well suited for use with processing devices 10 having shaking mechanisms 12 generating a circular oscillating motion with uniform tube orientation (i.e., rotating about an axis transverse to the tube longitudinal axes, with all of the tubes 30 in the tube holder 20 moved through the same circular motion profile while being maintained in the same orientation). It will be understood, however, that the carriage 40 with the clamp plate 44 can alternatively be used with processing devices having shaking mechanisms generating other oscillating motions such as those described herein.

Referring particularly to FIGS. 5-17, details of the controller 44, and its operation to move the clamp plate 44 between the clamping and clearance positions, will now be described. The controller 44 includes a control member 66 and a driven member 68. In the depicted embodiment, for example, the control member is an elongated rotary control member 66 and the driven member is a collar 68. The rotary control member 66 is rotationally mounted to the housing 42 so that the control member 44 rotates, but does not move up or down, relative to the housing 42. In the depicted embodiment, the rotary control member 66 extends all the way through the housing interior space 48 between the housing bottom 52 and top 54. In such embodiments, the rotary control member 66 can be rotationally mounted to the housing bottom 52 and top 54, for example by rotational bearings 70 and 72. In other embodiments, the control member extends only partially through the housing interior space and is rotationally mounted to other mounting elements of the housing located within the interior space. And in yet other embodiments, the control member moves linearly, for example laterally, to engage the collar or other driven member to move the clamp plate between the clamping and clearance positions.

The collar 68 is fixedly attached to the clamp plate 44 and engaged by the control member 66 so that rotation of the control member 44 moves the clamp plate 44 between the clamping and clearance positions. In the depicted embodiment, the collar 68 is fixedly attached to the clamp plate 44 by one or more conventional fasteners (e.g., screws, adhesives, etc.) and the control member 66 extends through it. In other embodiments, the collar or other driven member can be unitarily formed as an integral part of the clamp plate, or these components can be attached by other conventional attachments.

The engagement of the control member 66 and the driven member 68 can be by a conventional motion-converting mechanism that translates the motion (rotational) of the control member 44 to a linear motion of the clamp plate 44. For example, the motion-converting mechanism can include a rack-and-pinion gearset (e.g., with the control member including a pinion gear and the driven member including a rack gear), another type of gearset, a cam-and-follower mechanism (e.g., with the control member including a cam surface and the driven member including a spring-biased follower surface), or another mechanism that converts rotation of the control member 66 to translation of the clamp plate 44 between the clamping and clearance positions (with the control member 44 not moving up or down relative to the housing 42). In other embodiments, the motion-converting mechanism translates the rotational motion of the control member 44 to a linear motion of the clamp plate 44, with the control member 44 moving up and down when it rotates. In other embodiments, the control member is not rotary and instead is a laterally sliding member, with the control member and/or the driven member being a wedge member, and with the control member sliding laterally into engagement with the driven member to displace and linearly move the clamp plate into the clamping position and sliding laterally out of engagement to allow the clamping plate to be retracted to the clearance position (e.g., by spring biasing, gravity, or manually).

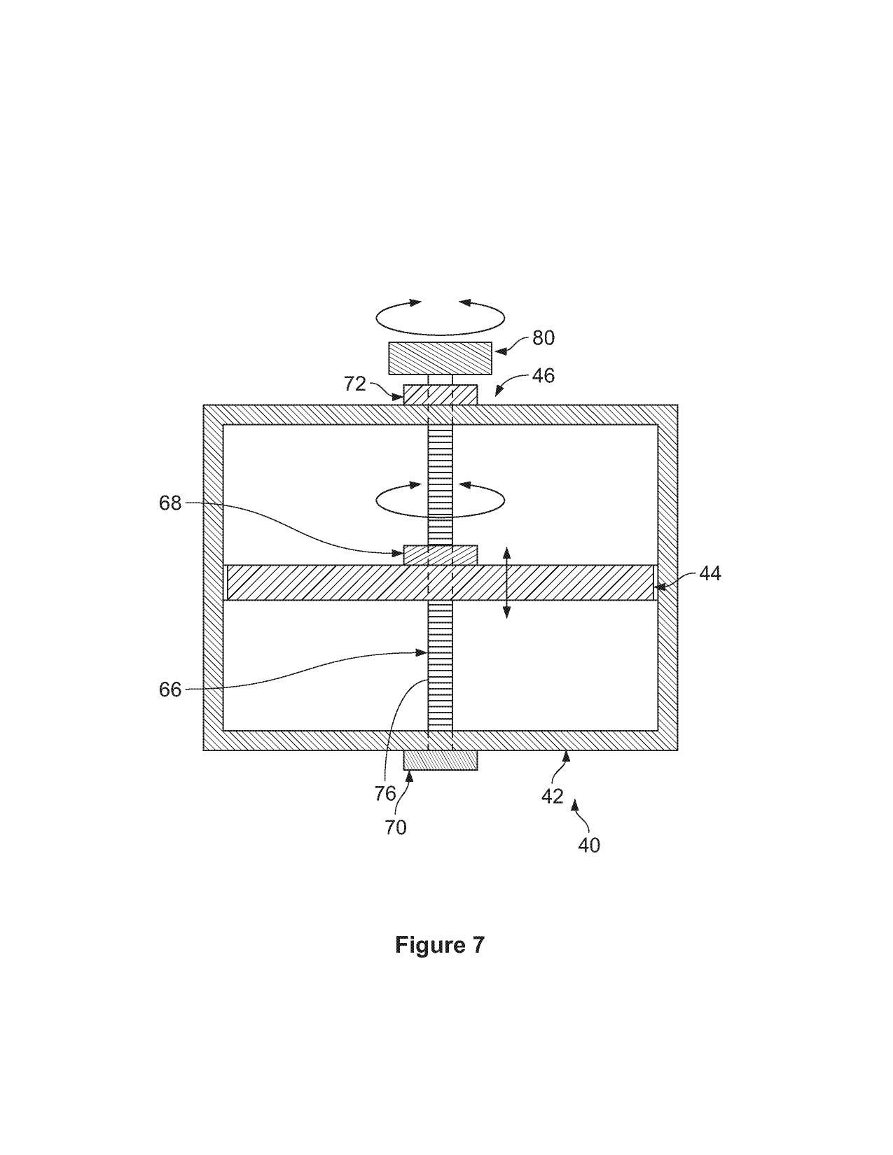

In example embodiments, the clamp plate 44 includes a vertically extending opening 74, the control member 66 extends through the clamp plate opening 74, and the driven collar 68 is aligned with the clamp plate opening 74 and receives the control member 66 through it. In the depicted embodiment, the rotary control member 66 is a control rod with an outer diameter having external screw threads 76, and the collar 68 has an aperture with an inner diameter having internal screw threads 78 that mate with the control member external threads 76. In this way, rotation of the control member 66 rotates its external threads 76, which impels the collar internal threads 78 and thus the clamp plate 44 to rotate. But the clamp plate 44 is restrained from rotation within the housing interior space 48 (as described in more detail below), so rotating the collar internal threads 78 instead drives the clamp plate 44 in a linear motion (between the clamping and clearance positions), as shown in FIGS. 7 and 12-13.

In other embodiments, the controller includes other types of control members and driven members adapted to selectively move the clamp plate between the clearance and clamping positions. For example, the controller can be provided by a fluid (e.g., air or hydraulic) cylinder device that pushes and pulls the clamp plate (e.g., with the control and driven members being reciprocating pistons and cylinders), a fluid (e.g., air) bladder with a pressure-control device (e.g., the control member) that inflates and deflates the bladder (e.g., the driven member), or a toggle-style clamp. These and other types of controllers (with or without control and driven members) can be used to provide the functionality described herein.

In addition, the controller 46 also includes a control interface 80 operably coupled to the control member 44 for a user to rotate the control member 44. The control interface 80 can include a manual interface (for a user to directly grasp by hand to manually manipulate the control member 66), an automated interface (for a user to input commands for computer-operated manipulation of the control member 66), both manual and automated interfaces, or hybrid/combination manual and automated interfaces. In other embodiments, the control interface slides or otherwise moves linearly, for example laterally, to move the control member during use.

In the depicted embodiment, the control interface 80 is a manual interface fixedly attached to the control member 44 and configured for a user to manually rotate it. The manual control interface 80 can be a knob (e.g., as depicted), crank, handle, or other structure that can be manually grasped and rotated by users. The manual control interface 80 can be attached to an input end of the control member 66 that extends above the top 54 of the housing 42 (e.g., as depicted), or it can be located elsewhere and attached to another part of the control member as may be desired for ease of use.

In any event, rotation of the control interface 80 causes the control member 66 to rotate relative to the housing 42, but neither the control interface 80 nor the control member 66 moves up or down relative to the housing 42. Because the control interface 80 remains in the same location (the same vertical position and spacing relative to the housing 42) when the clamp plate 44 is in the clamping and clearance positions (just with different angular orientations), the carriage 40 with the controller 46 is well suited for use with automated workflows. For example, the processing device 10 (or a separate laboratory machine) can include robotic grasping tools/implements (and a programmed controller) adapted to grasp and manipulate the control interface 80 to move the clamp plate 44 between the clamping and release positions (as well as to grasp and manipulate the tube holders 20 to move them into and out of the carriage 40). In such embodiments, the control interface 80 is a hybrid/combination manual and automated interface that can also be manually grasped and manipulated by a human user.

As noted above, the clamp plate 44 is restrained from rotation within the housing interior space 48, which causes the rotating driven collar threads 78 to drive the clamp plate 44 in a linear motion (between the clamping and clearance positions). To restrain the clamp plate 44 from rotating with the control member 66 (and thereby cause the clamp plate 44 to move linearly between the clamping and clearance positions), the housing 42 and the clamp plate 44 include abutting contact surfaces 82 and 84. These contact surfaces 82 and 84 abut each other to provide mechanical interference that blocks the clamp plate 44 from rotating relative to the housing 42.

In the depicted embodiment, the abutting contact surfaces 82 and 84 are formed on mating tabs and slots 86 and 88 defined by the clamp plate 44 and the housing

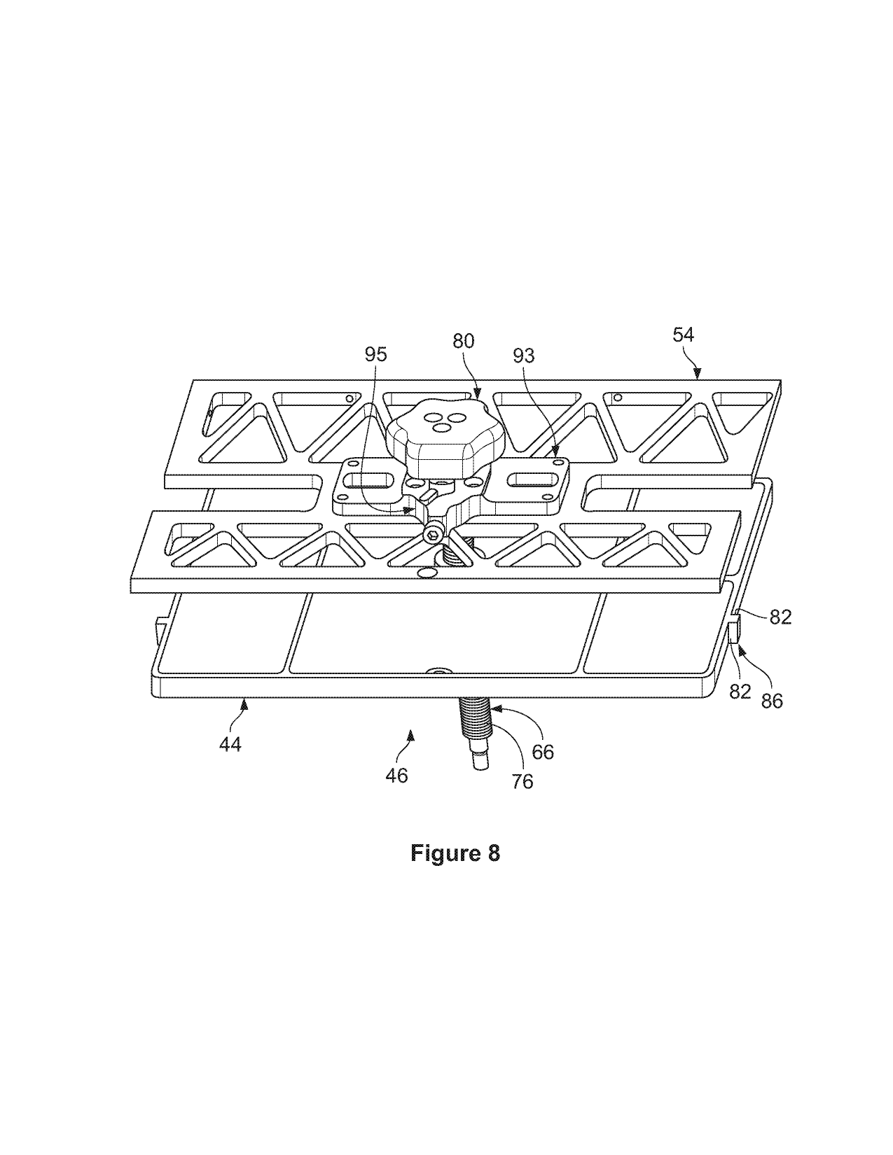

42. The tabs 86 can be formed on the left and right sides of the clamp plate 44, with the slots 88 formed in the left and right sides of the housing 42, as shown in FIGS. 8 and 10-11. The mating tabs 86 and slots 88 of this embodiment also function to smoothly guide the clamp plate 44 as it moves between the clamping and clearance positions. The mating slots 88 and tabs 86 further prevent the clamp plate 44 from shifting back and forth during processing, which limits bending on the control member 66. In other embodiments, the mating tabs and slots are in a vice versa arrangement, they are located on other portions of the clamp plate and housing, or they are formed by other structures (e.g., by two abutting protrusions) that provide the anti-rotation functionality. In yet other embodiments, the abutting contact surfaces are formed by edge surfaces of the clamp plate and by inner wall surfaces of the housing with the clamp plate and the interior space having conforming rectangular shapes in a closely nested arrangement.

As noted above, the clamp plate 44 moves between the clamping position securing the tube holder 20 and tubes 30 within the housing 42 and the clearance positioned for inserting and removing the tube holder 20 and tubes 30 into and out of the housing 42, and the controller 46 is operable to move the clamp plate between the clamping and clearance positions. In typical embodiments, the clearance and clamping positions are not discrete (predefined and indexed) positions, but instead are determined by the height of the tube holder 20 and tubes 30 being processed. This is enabled by the external threads 76 extending along a significant portion of the control member 44, for example along a significant portion of the height of the housing interior space 48 (e.g., all the way through it, as disclosed above, or at least the interior space above the shortest tube height to be used with the carriage 40).

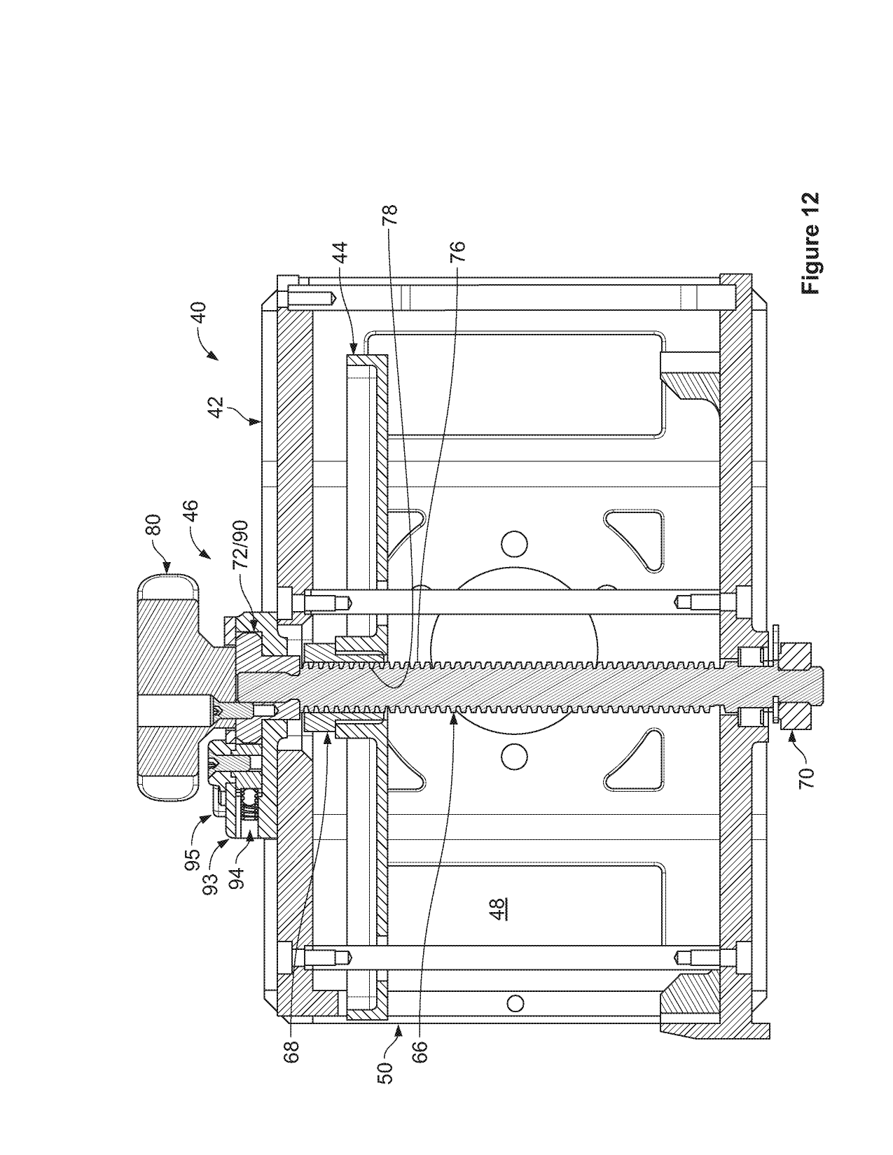

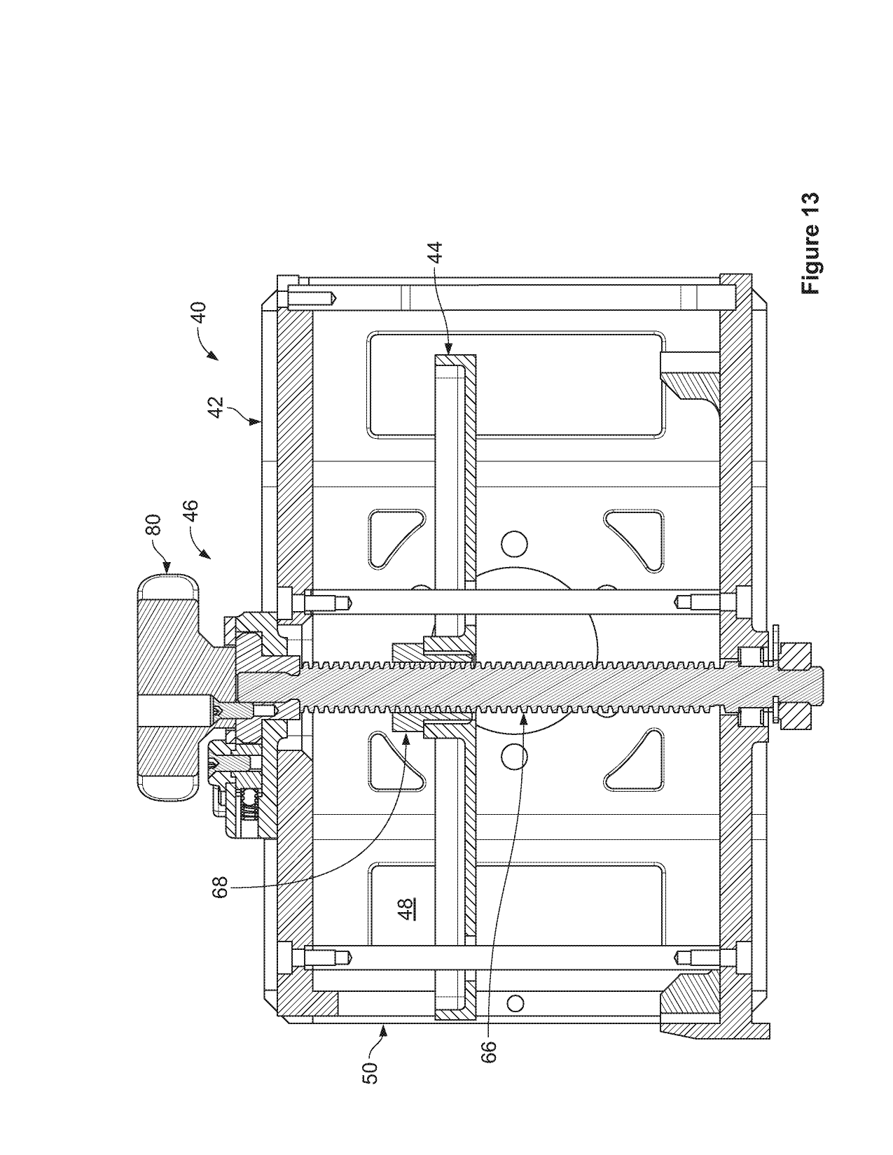

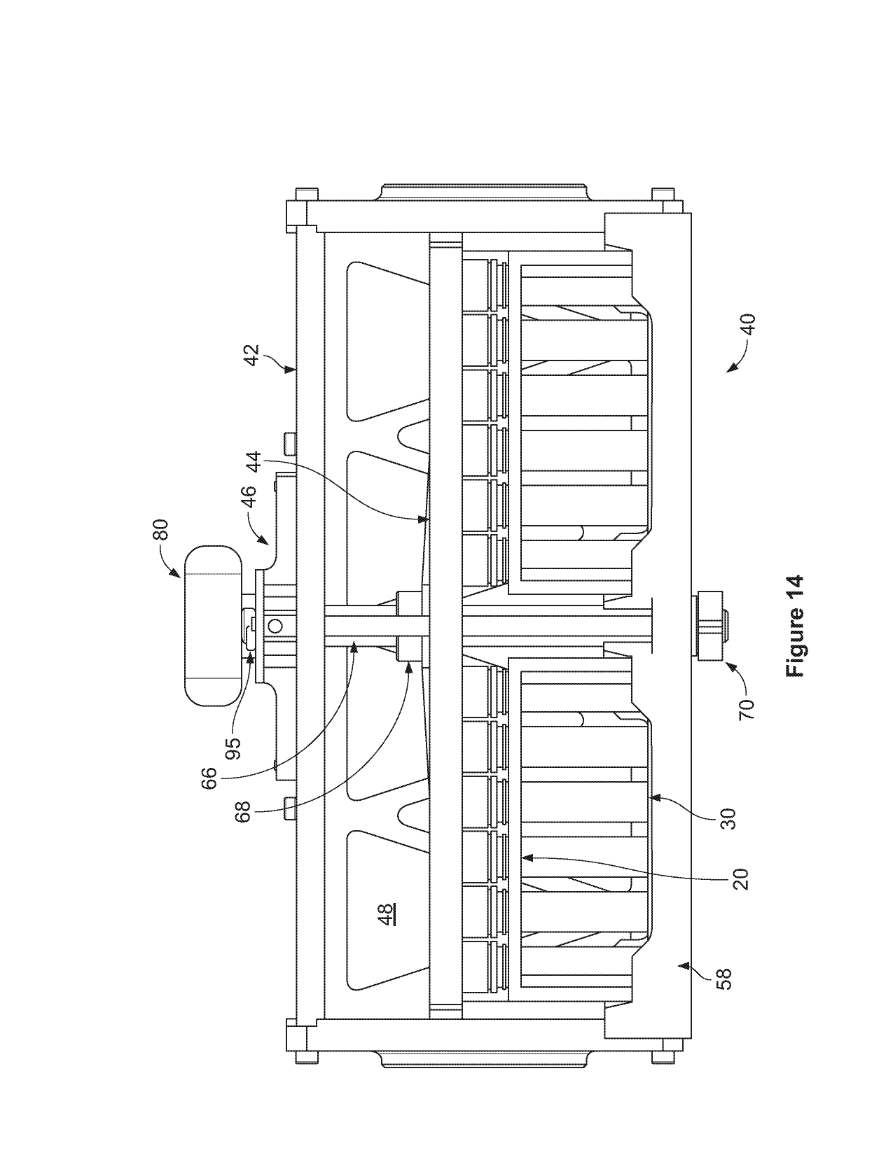

In this way, the controller 46 is operable to move the clamp plate 44 between a range of positions defining the clearance and clamping positions. The particular positions that are the clearance and clamping positions for each processing workflow are determined by the height of the tubes 30 being clamped. Thus, the clamp plate 44 is lowered less to the clamping position for relatively taller tubes 30 (e.g., 14 mL tubes) than for relatively shorter tubes 30 (e.g., 2 mL tubes). Similarly, the clamp plate 44 can be raised less to the clearance position for relatively shorter tubes 30 (e.g., 2 mL tubes) than for relatively taller tubes 30 (e.g., 14 mL tubes). For example, from the clearance position of FIG. 12, the clamp plate 44 is lowered less to the clamping position of FIGS. 13-14 for relatively taller tube holders 20 and tubes 30 (e.g., the depicted rack with screw-cap vials) than to the clamping position of FIG. 15 for relatively shorter tube holders and tubes 20a/30a (e.g., the depicted well plate). Also, the depicted clamp plate 44 has a flat bottom clamping surface that contacts the top portion of the tubes 30, so all of the tubes 30 in the tube holder 20 have the same relatively taller or shorter height for each processing batch. In other embodiments, the clamp plate can have a bottom clamping surface with a contoured shape selected to contact different heights of tubes in the same processing batch, for example two clamp-plate sections with different thicknesses for different height tubes.

Furthermore, the controller 46 typically includes a lock mechanism that is operable between locked and released positions. In the released position, the control member 44 is free to rotate in a first angular direction to move the clamp plate 44 to the clamping position and in an opposite second angular direction to move the clamp plate 44 to the clearance position. But in the locked position, the control member 44 is restrained from rotating in the second angular direction to retract the clamp plate 44 toward the clearance position. In this way, the locked clamp plate 44 secures the tube holder 20 with tubes 30 in place during processing use, so that vibrations from the extremely high energy and forces of processing do not cause the clamp plate 44 to loosen and retract from the clamping position during processing use.

For example, the lock mechanism can include a catch member 90 coupled to the control member 44 and an engagement member 92 selectively movable between locked and released positions. When the engagement member 92 is in the released position, it is free of engagement with the catch member 90, permitting the control member 44 (fixedly attached to the catch member 90) to rotate in the first (tightening) or second (loosening) angular direction. But when the engagement member 92 is in the locked position, it engages the catch member 90 to restrain it (and the control member 44 fixedly attached to it) from rotating in the second (loosening) angular direction to retract the clamp plate toward the clearance position.

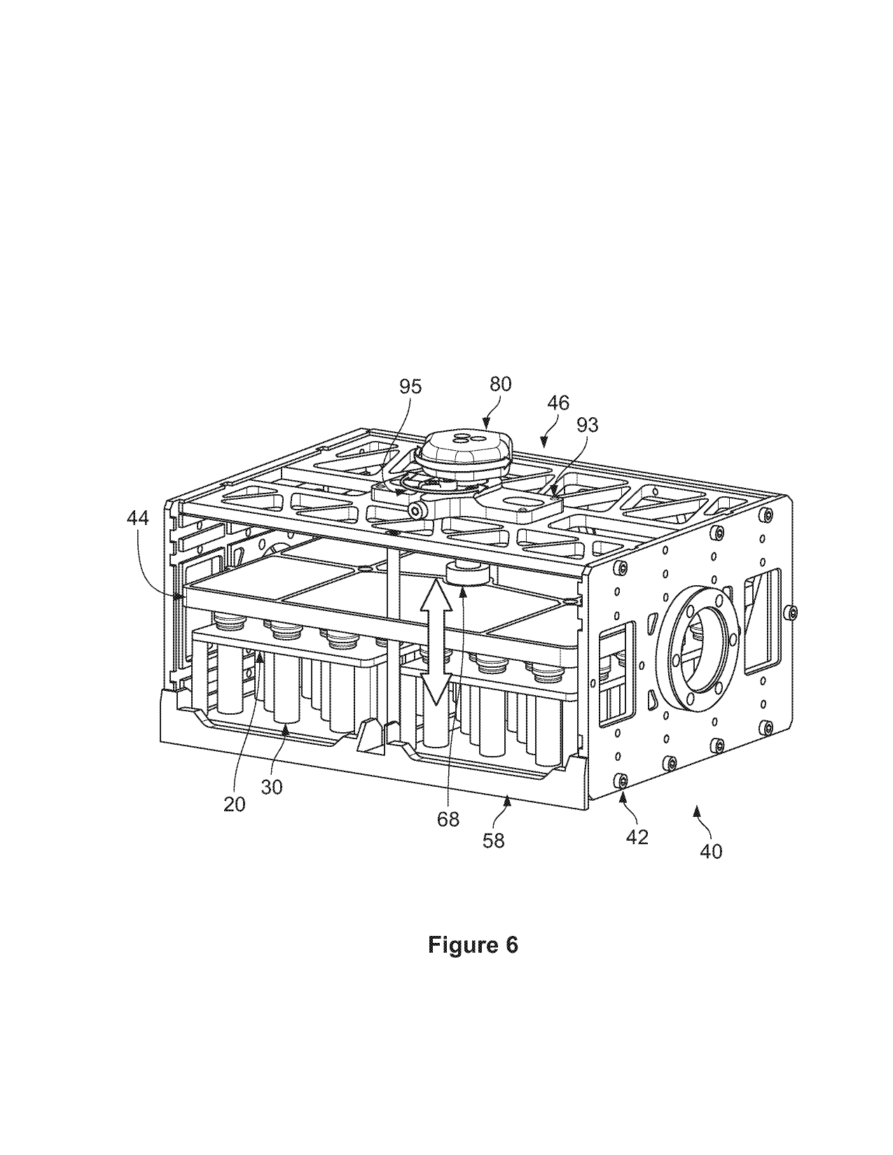

In the depicted embodiment, the catch member 90 is a ratchet member and the engagement member is a pawl member 92, as shown in FIGS. 6, 8-9, and FIGS. 16-17. In this embodiment, when the engagement member 92 is in the locked position, the catch member 90 and the attached control member 44 are free to rotate in the first angular direction to advance the clamp plate 44 to the clamping position. Thus, the lock mechanism does not need to be switched from the locked position to the released position to advance the clamp plate 44 to the clamping position, and so it does not need to be switched to the locked position to retain the clamp plate 44 in the clamping position, avoiding the potential for the user to inadvertently not lock the clamp plate 44 in place for processing use.

The ratchet catch member 90 can be circular with gear teeth that are engaged by the pawl engagement member 92, for example as depicted. The ratchet catch member 90 can be the same part as the rotational bearing 72 that rotationally mounts the control member 44 to the housing top 54 (e.g., depicted part 72/90), or it can be a separate part. The pawl engagement member 92 can be pivotally mounted to the housing top 54, for example by a mounting plate 93 that also seats the ratchet catch member 90, and biased toward the locked position by a spring element 94, which can also be seated in the mounting plate 93, for example as depicted. Also, the depicted lock mechanism includes an actuator 95 (e.g., a pivotal lever) fixedly attached to the pawl engagement member 92 so that moving the actuator 95 between the locked and released positions also moves the pawl engagement member 92 between the locked and released positions.

In other embodiments, the lock mechanism includes other ratchet catch members and/or other pawl engagement members that provide the same locked-position functionality. In yet other embodiments, instead of a ratchet-and-pawl mechanism, the lock mechanism includes other conventional catch and/or engagement members selectively movable between locked and released positions to provide the functionality of locking and releasing movement of the control member and thus the clamp plate.

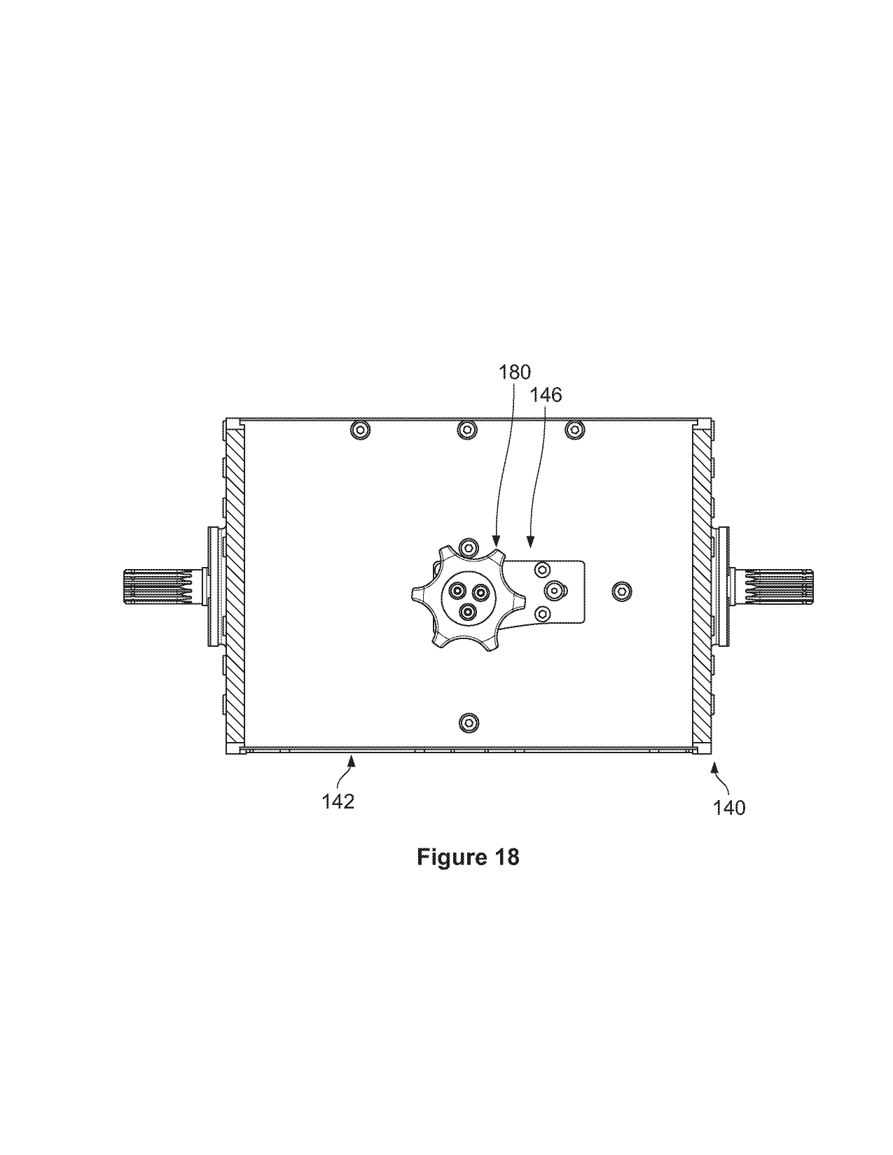

FIGS. 18-20 shows a tube carriage 140 according to a second example embodiment. The tube carriage 140 can be of the same or similar design and construction as that described above, expect as expressly noted herein. As such, the housing 142 receives and contains a tube holder (not shown) carrying tubes (not shown). And the tube carriage 140 includes a housing 142, a clamp plate (not shown), and a controller 146 that includes a control interface 180 and engaging control and driven members (not shown) that are operable to move the clamp plate between the clamping position (securing the tube holder and tubes within the housing 142 and the clearance position (for inserting and removing the tube holder and tubes into and out of the housing 142).

Also in this embodiment, the controller 146 includes a lock mechanism that is operable between a locked position (preventing movement of the clamp plate) and a released position (permitting movement of the clamp plate). The lock mechanism includes a catch member 190 coupled to the control member and an engagement member 192 selectively movable between locked and released positions.

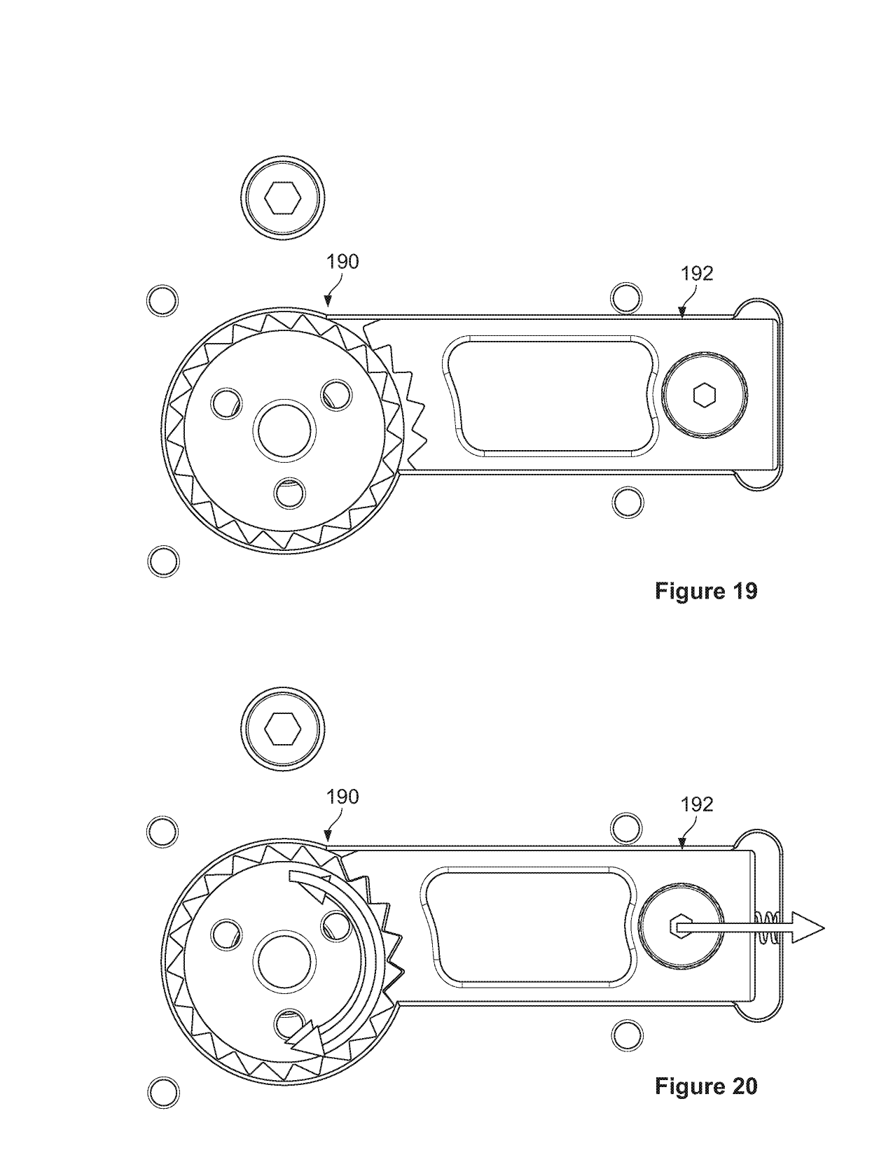

However, in this embodiment, the engagement member 192 is a linearly sliding member that is spring-biased into the locked position (FIG. 19) engaging the catch member 190 to restrain it (and the control member fixedly attached to it) from rotating in the second (loosening) angular direction to retract the clamp plate toward the clearance position. When the engagement member 192 is linearly slide against the spring force to the released position (FIG. 20), it is free of engagement with the catch member 190, permitting the control member (fixedly attached to the catch member 190) to rotate in the first (tightening) or second (loosening) angular direction. Thus, the lock mechanism of this embodiment is another type of ratchet-and-pawl system.

In another embodiment, a laboratory homogenizer or other processing device is provided that integrally includes at least one carriage that secures at least one tube holder holding plural tubes during homogenization or other processing of the samples. The processing device, and the tube holder and tubes, can be of types described herein or other conventional (current or future) types.

In some embodiments, a vision system (not shown) is included for visually monitoring the carriage 40, the tube holder 20, and/or the tubes 30. The vision system obtains data related to the carriage 40, the tube holder 20, and/or the tubes 30, and provides certain functionality based on that data. The vision system includes a camera

and a control system including a computer processor and software. The camera obtains the data and the computer processor and software interpret the obtained data and provide outputs to the user. Typically, the camera is mounted to the carriage (or to the processing device adjacent the carriage), and the control system is mounted to the processing device and in communication (wired or wireless) with the camera.

In example embodiments, the functionality provided by the vision system includes determining if the clamp plate is fully moved to the clamping position (securing the tube holder and tubes in place), what type of tube holder and tubes are installed into the carriage, and/or the quantity of tube holders and tubes installed into the carriage, as well as automatically providing output prompts of these determinations to the user. The vision system can also have user interface and speed settings change based on the vision-related data output to the user.

In this way, the vision system can identify if the tube-holder racks or plates are fully seated into the carriage. While scanning the carriage, the vision system can also identify both the quantity and type of the tube-holder racks or plates placed into the carriage. With this information, the software can present the user with a confirmation prompt for the tube-holder rack or plate type placed into the carriage. The software can also change the user interface and parameters based on the vision information presented to the user.

It is to be understood that this disclosure is not limited to the specific devices, methods, conditions, or parameters of the example embodiments described and/or shown herein, and that the terminology used herein is for the purpose of describing particular embodiments by way of example only. Thus, the terminology is intended to be broadly construed and is not intended to be unnecessarily limiting of the claimed subject matter. For example, as used in the specification including the appended claims, the singular forms “a,” “an,” and “the” include the plural, the term “or” means “and/or,” and reference to a particular numerical value includes at least that particular value, unless the context clearly dictates otherwise. Also, any use of the terms “about,” “substantially,” and/or “generally” are intended to mean the exact value or characteristic indicated, as well as close approximations that are understood by persons of ordinary skill in the art to be sufficiently close to the exact value or characteristic based on the context of the intended use and application. In addition, any methods described herein are not intended to be limited to the sequence of steps described but can be carried out in other sequences, unless expressly stated otherwise herein.

While the claimed embodiments have been shown and described in example forms, it will be apparent to those skilled in the art that many modifications, additions, and deletions can be made therein without departing from the spirit and scope of the disclosure as defined by the following claims.

What is claimed is:

1. A carriage configured to mount to a processing device, the carriage comprising:
a housing including an interior space and a side opening in communication with the interior space, wherein the interior space is configured to contain one or more tube holders comprising one or more tubes, wherein the side opening is configured to receive the one or more tube holders into the interior space, and wherein the housing includes at least one mount configured to attach to the processing device;
a clamp plate positioned within the housing interior space and movable between a clamping position and a clearance position, wherein in the clearance position the clamp plate provides clearance enabling the one or more tube holders to be inserted into and removed from the interior space, and wherein in the clamping position, with the one or more tube holders within the interior space, the clamp plate contacts the one or more tube holder and/or the one or more tubes to retain the tube holder and/or one or more tubes between the clamp plate and the housing in a fixed position during use of the processing device to process the samples; and
a controller including a control member and a driven member engaged and driven by the control member, wherein the control member and the driven member are adapted to selectively move the clamp plate between the clearance and clamping positions.

2. The carriage of claim 1, wherein the housing includes a bottom, a top, and four sides extending between the top and the bottom, the side opening is formed in a front one of the housing sides, the clamp plate clearance position is raised within the housing interior space relative to the clamp plate clamping position, and the clamp plate in the clamping position applies a compressive force between the clamp plate and the housing bottom.

3. The carriage of claim 1, wherein the housing includes a bottom lip that retains the one or more tube holders within the carriage when the one or more tube holders are in a seated position within the housing interior space.

4. The carriage of claim 3, wherein the bottom lip is positioned below the side opening, has a top edge that defines a bottom of the side opening, and has an inner surface that defines a portion of the housing interior space, wherein the one or more tube holders insert laterally through the side opening, over the top edge of the bottom lip, and into the interior space, and then drop downward within the interior space into the seated position, wherein when the one or more tube holders is in the seated position, the inner surface of the bottom lip retains the one or more tube holders from moving laterally out through the side opening.

5. The carriage of claim 1, wherein the clamp plate in the clamping position contacts a portion of the one or more tubes extending above the one or more one or more tube holders.

6. The carriage of claim 1, wherein all of the one or more tubes in the one or more tube holders have the same relatively taller or shorter height, wherein the controller is configured to move the clamp plate between a range of the clearance and clamping positions such that the clearance and clamping positions are not discrete positions but instead are determined by the height of the one or more one or more tubes being clamped, wherein for the relatively taller one or more tubes the clamp plate is lowered less to the clamping position than for the relatively shorter one or more tubes.

7. The carriage of claim 1, wherein the control member is an elongated rotary control member and the driven member is a collar, wherein the control member is rotationally mounted to the housing so that the control member rotates, but does not move up or down, relative to the housing, and wherein the collar is fixedly attached to the clamp plate and engaged by the control member so that rotation of the control member moves the clamp plate between the clamping and clearance positions.

8. The carriage of claim 7, wherein the clamp plate includes a vertically extending opening, wherein the elongated rotary control member extends through the clamp plate opening, and wherein the collar is aligned with the clamp plate opening and receives the control member therethrough.

9. The carriage of claim 8, wherein the elongated rotary control member is a control rod having screw threads, wherein the collar has screw threads that mate with the control member threads so that rotation of the control member drives the clamp plate between the clamping and clearance positions.

10. The carriage of claim 7, wherein the housing and the clamp plate include abutting contact surfaces that abut each other to restrain the clamp plate from rotating with the elongated rotary control member to thereby cause the clamp plate to move between the clamping and clearance positions.

11. The carriage of claim 10, wherein the housing and the clamp plate include mating guide tabs and slots that define the mating contact surfaces, wherein the guide tabs and slots are adapted to guide the clamp plate between the clamping and clearance positions.

12. The carriage of claim 7, wherein the elongated rotary control member extends through the housing, between a top and bottom of the housing, and is rotationally mounted to the housing top and bottom.

13. The carriage of claim 7, wherein the control member includes an input end extending above the housing, and wherein the control mechanism further includes a control interface attached to the control member input end and adapted to rotate the control member, wherein the control interface rotates, but does not move up or down, relative to the housing.

14. The carriage of claim 7, wherein the controller further includes a lock mechanism including a catch member coupled to the elongated rotary control member and an engagement member selectively movable between locked and released positions, wherein the engagement element in the released position is free of engagement with the catch member so that the control member is free to rotate in a first angular direction to move the clamp plate to the clamping position and in an opposite second angular direction to move the clamp plate to the clearance position, wherein the engagement element in the locked position engages the catch member so that the control member is restrained from rotating in the second angular direction to retract the clamp plate toward the clearance position so that the clamp plate secures the tube holder with tubes in place.

15. The carriage of claim 14, wherein the catch member is a ratchet and the engagement member is a pawl, wherein in the locked position the control member is free to rotate in the first angular direction to advance the clamp plate to the clamping position.

16. The processing device and the carriage of claim 1 in combination, wherein the processing device is a homogenizer and the carriage is attached to the homogenizer.

17. A carriage configured to mount to a processing device, the carriage comprising:
a housing including an interior space, a side opening in communication with the interior space, and a bottom lip, wherein the interior space is configured to contain one or more tube holders comprising one or more tubes, wherein the side opening is configured to receive the one or more tube holders into the interior space, and wherein the bottom lip is configured to retain the tube holder with tubes within the carriage when the tube holder with tubes is in a seated positioned within the housing interior space;
a clamp plate positioned within the housing interior space, including a vertically extending opening, and movable between a clamping position and a clearance position, wherein in the clearance position the clamp plate provides clearance enabling the one or more tube holders to be inserted into and removed from the interior space, and wherein in the clamping position, with the one or more tube holders within the interior space, the clamp plate contacts the one or more tube holders and/or the one or more tubes to retain the one or more tube holders and/or the one or more tubes between the clamp plate and the housing in a fixed position during use of the processing device to process the samples; and
a controller adapted to selectively move the clamp plate between the clearance and clamping positions, wherein the controller includes an elongated rotary control member and a collar, wherein the control member includes screw threads, extends through the clamp plate opening, and is rotationally mounted to the housing so that the control member rotates, but does not move up or down, relative to the housing, and wherein the collar is fixedly attached to the clamp plate, is aligned with the clamp plate opening, receives the control member therethrough, and has screw threads that mate with the control member threads so that rotation of the control member drives the clamp plate between the clamping and clearance positions,
wherein the housing and the clamp plate include abutting contact surfaces that restrain the clamp plate from rotating with the elongated rotary control member to thereby cause the clamp plate to move between the clamping and clearance positions.

18. The carriage of claim 17, wherein the controller further includes a lock mechanism including a catch member coupled to the elongated rotary control member and an engagement member selectively movable between locked and released positions, wherein the engagement element in the released position is free of engagement with the catch member so that the control member is free to rotate in a first angular direction to move the clamp plate to the clamping position and in an opposite second angular direction to move the clamp plate to the clearance position, wherein the engagement element in the locked position engages the catch member so that the control member is restrained from rotating in the second angular direction to retract the clamp plate toward the clearance position, wherein in the locked position the clamp plate secures the tube holder with tubes in place.

19. The processing device and the carriage of claim 17 in combination, wherein the processing device is a homogenizer and the carriage is attached to the homogenizer.

20. The carriage of claim 17, wherein the housing interior space is configured to contain two of the tube holders each holding an array of the sample tubes.
